(19) United States
(12) Patent Application Publication
(10) Pub. No.: US 2014/0164371 A1
(43) Pub. Date: Jun. 12, 2014

(54) EXTRACTION OF MEDIA PORTIONS IN ASSOCIATION WITH CORRELATED INPUT

(71) Applicant: RAWLLIN INTERNATIONAL INC., Tortola (VG)

(72) Inventors: Måns Anders Tesch, Gard (FR); Johan Magnus Tesch, London (GB); Aleksandra Sanches-Peres, Saint-Petersburg (RU)

(73) Assignee: RAWLLIN INTERNATIONAL INC., Tortola (VG)

(21) Appl. No.: 13/710,344

(22) Filed: Dec. 10, 2012

(51) Int. Cl. G06F 17/30

(52) U.S. Cl. CPC G06F 17/30038
USPC 707/731

(57) ABSTRACT

A multimedia message is generated with a set of media content portions that corresponds to a set of inputs. Media content portions are concatenated together to generate a continuous stream of media extracted from different media content. The media content portions are extracted to correspond to words or phrases of the set of inputs. The media content portions are identified and classified according to a set of predetermined criteria. The order of the media content portions can be modified and different video and/or audio portions can be selected to correspond with the words or phrases.

### TECHNICAL FIELD

The subject application relates to media content and messages related to media content, e.g., to the composition of messages including extracting media portions in association with a set of inputs.

### BACKGROUND

Media content can includes various different forms of media and the contents that make up the different forms of media. For example, a film or video, also called a movie or motion picture, is a series of still or moving images that are rapidly put together and projected onto/from a display, such as by a reel on a projector device, or some other device, depending upon what generation a person is from. The video or film is produced by recording photographic images with cameras, or by creating images using animation techniques or visual effects. The process of filmmaking has developed into an art form and a large industry, which continues to provide entertainment to masses of people, especially during times of war or calamity.

Videos are made up of a series of individual images called frames, or also referred to herein as clips. When these images are shown rapidly in succession, a viewer has the illusion that motion is occurring. Videos and portions of videos can be thought of as cultural artifacts created by specific cultures, which reflect those cultures, and, in turn, affect them. Film is considered to be an important art form, a source of popular entertainment and a powerful method for educating or indoctrinating citizens. The visual elements of cinema give motion pictures a universal power of communication. Some films have become popular worldwide attractions by using dubbing or subtitles that translate the dialogue into the language of the viewer.

To these ends, people continue to express themselves in novel and different ways by leaving behind classical films that not only mark generations, but provide the shoulders for new generations to stand upon, subject to copyright laws. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and media content portions corresponding to a set of inputs are contained herein. An exemplary system comprises a memory that stores computer-executable components and a processor, communicatively coupled to the memory, which facilitates execution of the computer-executable components. The computer-executable components comprise a media search component configured to identify a set of media content in a set of data stores based on a set of words or phrases. A media clipping component is configured to extract a set of media content portions from the set of media content based on a set of predetermined criteria. The computer-executable components further include a concatenating component configured to assemble at least one media content portion of the set of media content portions into a multimedia message based on a set of inputs received for the multimedia message.

In another non-limiting embodiment, an exemplary method comprises identifying, by a system including at least one processor, a set of video content and audio content in a set of data stores based on a set of words or phrases for a multimedia message. A set of video content portions and audio content portions that correspond to the set of words or phrases are extracted according to a set of predetermined criteria. At least one video content portion and at least one audio content portion of the set of video content portions and audio content portions is assembled into the multimedia message based on a set of inputs having the set of words or phrases.

In still another non-limiting embodiment, an exemplary computer readable storage medium comprising computer executable instructions that, in response to execution, cause a computing system including at least one processor to perform operations. The operations comprise searching for a set of words or phrases among a set of video content and audio content in a set of data stores. At least one word or phrase of the set of words or phrases is identified within the set of video content and audio content searched according to a set of classification criteria. The operations include extracting a set of video content portions and audio content portions having audio content that matches the word or phrase based on the set of classification criteria, and indexing the set of video content portions and audio content portions having the at least one word or phrase of the set of words or phrases that are pre-associated with video content and audio content of the set of video content and audio content in the set of data stores according to at least one of the at least one word or phrase, or the classification input.

In another non-limiting embodiment, an exemplary system comprises means for identifying a set of media content in a set of data stores based on a set of words or phrases for a multimedia message. The system includes means for extracting a set of media content portions having video content and audio content pre-associated with one another that correspond to the set of words or phrases, and means for assembling at least one media content portion of the set of media content portions into the multimedia message based on a set of inputs having the set of words or phrases.

The following description and the annexed drawings set forth in detail certain illustrative aspects of the disclosed subject matter. These aspects are indicative, however, of but a few of the various ways in which the principles of the various innovations may be employed. The disclosed subject matter is intended to include all such aspects and their equivalents. Other advantages and distinctive features of the disclosed subject matter will become apparent from the following detailed description of the various innovations when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system in accordance with various aspects described herein;

FIG. 2 illustrates another example system in accordance with various aspects described herein;

FIG. 3 illustrates another example system in accordance with various aspects described herein;

FIG. 4 illustrates another example system in accordance with various aspects described herein;

FIG. 5 illustrates an example view pane in accordance with various aspects described herein;

FIG. 6 illustrates an example system flow diagram in accordance with various aspects described herein;

FIG. 7 illustrates an example of a flow diagram showing an exemplary non-limiting implementation for a system for generating a multimedia message in accordance with various aspects described herein;

FIG. 8 illustrates another example of a flow diagram showing an exemplary non-limiting implementation for a system for generating multimedia message in accordance with various aspects described herein;

FIG. 9 illustrates another example system in accordance with various aspects described herein;

FIG. 10 illustrates another example system in accordance with various aspects described herein;

FIG. 11 illustrates an example view pane of a slide reel in accordance with various aspects described herein;

FIG. 12 illustrates another example message component in accordance with various aspects described herein;

FIG. 13 illustrates an example media component in accordance with various aspects described herein;

FIG. 14 illustrates another example of a flow diagram showing an exemplary non-limiting implementation for a system for evaluating media content in accordance with various aspects described herein;

FIG. 15 illustrates another example of a flow diagram showing an exemplary non-limiting implementation for a system for evaluating media content in accordance with various aspects described herein;

FIG. 16 is a block diagram representing exemplary non-limiting networked environments in which various non-limiting embodiments described herein can be implemented; and

FIG. 17 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

In consideration of the above-described trends or deficiencies among other things, various embodiments are provided that generate a message for a user that includes a sequence of media clips or media content portions. The media content portions can include, for example, portions of video and/or audio content from movies and/or songs. A system having a processor and a memory generates the message that comprises a multi-media message, or a message having multiple different media contents having a sequence of concatenated media content portions. The message is generated in response to a set of inputs being received, for example, as part of a text, voice, touch and/or selection input and then communicated, such as by a text message on a mobile device (e.g., a mobile phone or other computer device). The inputs received by the system can be a typed input, a predetermined input (e.g., word or phrase) selection, a voice input and/or the like inputs for generation of the message. Components of the system generate a set of media content portions, such as a portion, segment, and/or clip of a movie, and/or an audio content (e.g., song, speech, and the like). The message is then assembled together as a sequence of clips with audio and/or video content that corresponds to the textual inputs received and including video content portions and/or audio content portions from videos and audios stored in a data base. The system identifies portions of content within entire videos and audio recordings, such as movies and films that are stored in one or more data stores. The system further extracts the portions of video and/or audio that correspond to different words or phrases and indexes the portions according to a set of predetermined criteria and/or predetermined classification criteria for future use and easy reference. For example, the system receives a set of inputs that conveys a message with a set of words or phrases. The system generates the message with the portions of media content that correspond to each word or phrases by concatenating the portions together to convey the same message as received in the set of inputs. The system enables modification of the media content portions to correspond to different words and/or to replace media content portions generated as corresponding to the input (e.g., phrases, words images, etc.). The message can comprise a multi-media message and can be communicated via a computer device, such as a mobile phone, and/or some other mobile device in order to enable a more expressive message that not only embodies video and audio content dynamically generated according to a user's taste and personality.

The words “portion,” “segment,” “scene,” “clip”, and “track” are used interchangeably herein to indicate a section of video and/or audio content that is generally meant to indicate less than the entirety of the video or audio recording, but can also include the entirety of a video or audio recording, and/or image, for example. Additionally, these words, as used herein can have the same meaning, such as to indicate a piece of media content. A scene generally indicates a portion of a video or a segment of a video, for example, however, this can also apply to a song, speech or any audio content for purposes herein to indicate a portion or a piece of an audio bite or sound recording, which may or may not be integral to, or accompany, a video.

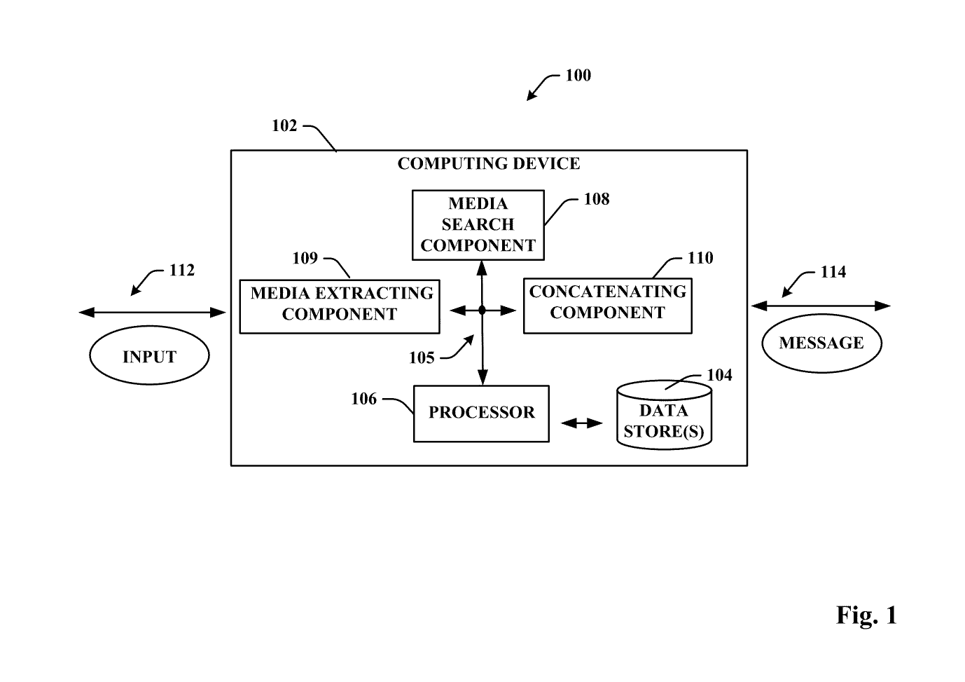

Referring initially to FIG. 1, illustrated is an example system 100 that generates one or more messages having media content that corresponds to a set of text inputs in accordance with various aspects described herein. The one or messages generated can include a set of media content portions having one or more portions of video, audio and/or image content extracted from larger video and/or audio recordings. For example, in response to being viewed, a message generates a message that can comprise multiple portions of different videos (e.g., movies) of different video files, of different audio files, and/or of image files. Each of the portions, for example, can correspond to a word, phrase and/or gesture. The system 100 is operable to create the message from the portions of media content that correspond to the words, phrases, and/or gestures of a set of inputs. The messages therefore can generate a video/audio stream that is a continuous media stream comprising, for example, multiple sound bites being played, multiple video segments being played, and/or multiple images being played from multiple different video, audio and/or images. For example, a video portion corresponding to one word is concatenated with a video portion corresponding to another word, and in response, the message plays two video portions in a sequence, in which each video portion plays a portion of a video or movie that corresponds to a word inputted to the system.

The system 100 is operable as a networked messaging system that communicates multi-media messages, such as to a computing device, a mobile device, mobile phone, and the like. The system 100, for example, includes a computing device 102 that can comprise a personal computer device, a handheld device, a personal digital device (PDA), a mobile device (e.g., a mobile smart phone, laptop, etc.), a server, a host device, a client device, and/or any other computing device. The computing device 102 comprises a memory 104 for storing instructions that are executed via a processor 106. The system 100 can include other components (not shown), such as an input/output device, a power supply, a display and/or a touch screen interface panel. The system 100 and the computing device 102 can be configured in a number of other ways and can include other or different elements. For example, computer device 102 may include one or more output devices, modulators, demodulators, encoders, and/or decoders for processing data.

The memory or data store(s) 104 can include a random access memory (RAM) or another type of dynamic storage device that may store information and instructions for execution by the processor 106, a read only memory (ROM) or another type of static storage device that can store static information and instructions for use by processing logic, a flash memory (e.g., an electrically erasable programmable read only memory (EEPROM)) device for storing information and instructions, and/or some other type of magnetic or optical recording medium and its corresponding drive.

A bus 105 permits communication among the components of the system 100. The processor 106 includes processing logic that may include a microprocessor or application specific integrated circuit (ASIC), a field programmable gate array (FPGA), or the like. The processor 106 may also include a graphical processor (not shown) for processing instructions, programs or data structures for displaying a graphic, such as a message generated by embodiments disclosed that comprises a continuous stream of video content portions and/or audio content portions, which include segments of a movie, song, speech, filmed event, each including video and/or audio. The message can therefore comprise one or more portions of video/audio content portions, in which each portion is a smaller segment of a larger video and/or audio that plays the smaller segment in a continuous sequence of one portion after the other portion within the message, and according to the order and association to a set of words and/or phrases received in a set of inputs 112.

The set of inputs 112 can be received via an input device (not shown) that can include one or more mechanisms in addition to touch panel that permit a user to input information to the computing device 102, such as microphone, keypad, control buttons, a keyboard, a gesture-based device, an optical character recognition (OCR) based device, a joystick, a virtual keyboard, a speech-to-text engine, a mouse, a pen, voice recognition, a network communication module, etc.

The computing device 102 includes a media search component 108 that identifies a set of media content from one or more data stores 104 based on a set of words or phrases. For example, a video and/or an audio such as a movie or song (e.g., “Streets of Fire,” U2-“Streets have no name”) can be identified by the search. In response to being identified, the media content can be tagged and indexed with metadata that further identifies and/or classifies the media content.

In one embodiment, the media search component 108 is configured to search large volumes of memory storage and different data storages that can have multiple different types of libraries, files, applications, video content, audio content, etc., as well as to search data stores of third party servers, cloud resources, data stores of client devices, such as mobile devices. The media search component can identify video content (e.g., movies, home videos, video files, etc.) and/or audio content (e.g., movies, videos, video files, songs, audio books, audio files, etc.) from the data store(s) searched. The media search component 108 can search for media content based on a set of predetermined criteria. For example, the media search component 108 can search media content based on predefined classifications, such as use preferences that can includes, a theme, an artist, an actor or actress, a rating, a target audience, time period, author, and the like. The media search component 108 is configured to search for the set of media content based on query terms, for example, that can be provided at a search input field or initiated by a graphical interface control by a user. Additionally or alternatively, the media content search component 108 is configured to search data stores based on a set of words or phrases within the video content and/or audio content (e.g., a video file, audio file, etc.).

In another embodiment, the media search component 108 is configured to identify video and/or audio content without receiving input, but only media content. In conjunction with an indexing component (discussed infra) the media search component only has to classify each media content (video content and audio content) and associate the content with an index of words and phrases contained within each media content file, for example.

In another embodiment, the media search component 108 is configured to search a set of data stores for media content based on the set of inputs 112 received by the compute device 102. For example, the media search component 108 is configured to dynamically search and identify content within a set of media content in a set of data stores that comprises and corresponds to a set of words or phrases of the set of inputs 112. For example, in response to receiving the phrase, “I'll be coming for her, and I'll be coming for you too”, the media search component 108 can identify the movie, “Streets of Fire” in the data store 104 and outputs the particular media content (“Streets of Fire”) as a candidate for extraction to a media extracting component 109.

The media extraction component 109 is communicatively coupled to the media search component 108, and receives media content that has been identified by the media search component 108. The media extraction component 109 is configured to extract portions of media content from a video, and/or an audio recording that can respectively comprise a plurality of words and/or phrases as part of the video, audio recording, and the like, so that when each portion is played a portion of the video, audio, etc., is played. Each portion, for example, includes scenes, and/or song portions that include the word and/or phrase of the set of inputs 112 received. The media extraction component 109 is configured to extract a set of media content portion from a set of media content based on the set of predetermined criteria, or a set of predetermined extraction criteria.

In one embodiment, the predetermined extraction criteria includes a matching of the words or phrases within the set of media content with the words and phrases of the set of inputs. Additionally or alternatively, the extraction can be a predetermined extraction according to words in a dictionary or other predefined words or phrases. The words, and/or phrases can be then indexed with the extracted portions of media that match the words and/or phrases. The media extraction component 109 extracts the portions according to the set of predetermined criteria including a predefined location of where to cut, divide and/or segment a video recording, and/or audio recording (e.g., a video movie, song, speech, video/audio file, such as a .wav file and the like). The media extraction component 109 can extract precise portions of media so that a multimedia message can be generated that includes a plurality of portions that each include movie scenes or song lines. The predetermined criteria can include a vague extraction, an estimated extraction or, in other words, an imprecise extraction so that words, phrases, and/or scenes surrounding the particular word and/or phrase of interest are also included within the portion extracted. This can provide further context of to the word or phrases, in which the portion extracted corresponds to or generate portions of video/audio on demand dynamically by providing a word or phrase via an input, such as a text, voice, selection, and/or other type input. The predetermined criteria can includes at least one of a classification of a set of classification and a matching of media content portions of the set of media content portions from the media content identified with a set of words or phrases. A matching audio clip or portion within the set of media content portions and/or a matching action to the words or phrases can also be part of the set of predetermined criteria by which the media extraction component 109 extracts portions of video/audio content from media content files or recordings.

The computing device 102 further includes a concatenating component 110 that is configured to a concatenating component configured to assemble at least one media content portion of the set of media content portions into a multimedia message based on the set of inputs 112 received for the multimedia message. The inputs 112 can be a selection input of predefined words and/or phrases that correspond, or are correlated to the portions of media content extracted. In addition or alternatively, the inputs 112 can include voice inputs, text inputs, and/or digital handwritten inputs with a touch screen or with a stylus. Thus the concatenation component 110 generates a continuous stream of media content portions that make up a multimedia message. In response to the message being played, different portions of different video/audio content are played as a continuous video/audio, in which each of the portions include various scenes, musical notes, words, phrases, etc. that play a portion of the original and entire video and/or audio content from which they were extracted from. The concatenation component 110 is configured to splice various portions together to form one continuous stream of video/audio that can then be sent as a message 114 with each word or phrase corresponding to the set of inputs 112 received by the system 100.

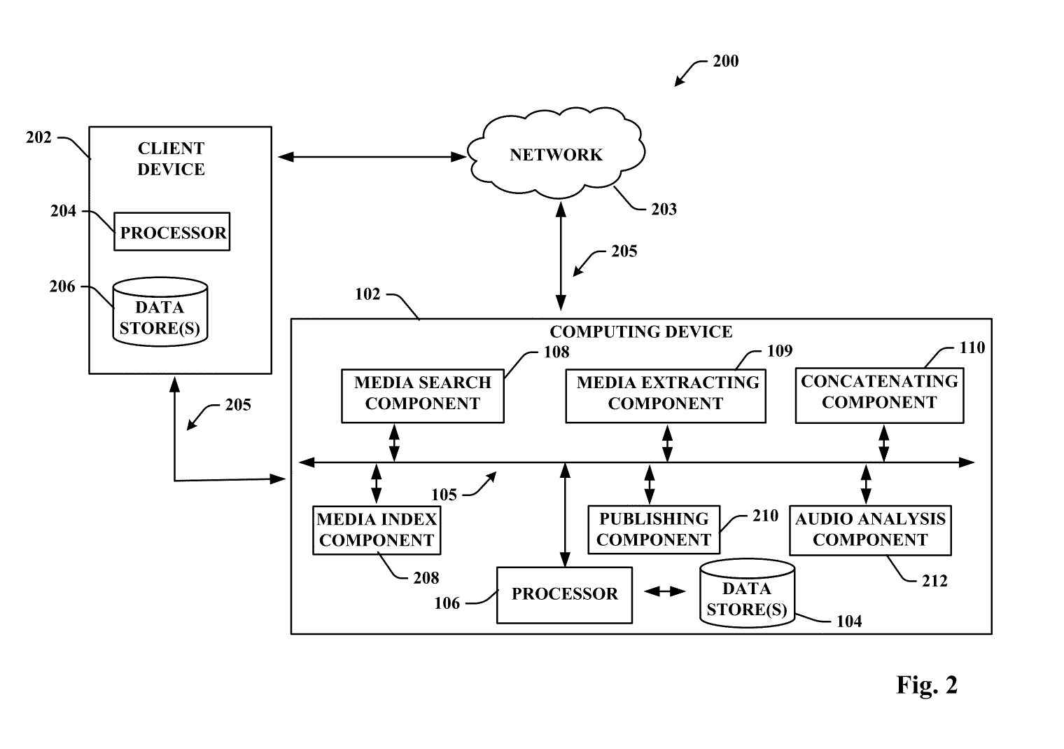

Referring now to FIG. 2, illustrated is a system 200 that operates to extract media content portions from media content for generation of a multimedia message. The system 200 includes the computing device 102 that is communicatively coupled to a client device 202 via a communication connection 205 and/or a network 203 for receiving input and communicating a multimedia message generated by the computing device 102.

The client device 202 can comprise a computing device, a mobile device and/or a mobile phone that is operable to communicate one or more message to other devices via an electronic digital message (e.g., a text message, a multimedia text message and the like). The client device 202 includes a processor 204 and at least one data store 206 that processes and stores portions of media content such as video clips of a video comprising multiple video clips, portions of videos and/or portions of audio content and image content that is associated with the videos. The media content portions include portions of movies, songs, speeches, and/or any video and audio content segments that generate, recreate or play the portion of the media content that the media content portions are extracted from. The clips, portions or segments of media content can also be stored in an external data store, or any number of data stores such as a data store 104 and/or data store 206, in which the media content can include portions of songs, speeches, and/or portions of any audio content.

The client device 102 is configured to communicate to other client devices (not shown) and to the computer device 102 via the network 203. The client device 102, for example, can communicate a set of text inputs, such as typed text, audio or any other input that generates a digital typed message having alphabetic, numeric and/or alphanumeric symbols for a message. For example, the client device 202 can communicate via a Short Message Service (SMS) that is a text messaging service component of phone, web, or mobile communication systems, using standardized communications protocols that allow the exchange of short text messages between fixed line and/or a wireless connection with a mobile device. The network 203 can include a cellular network, a wide area network, local area network and other like networks, such as a cloud network that enables the delivery of computing and/or storage capacity as a service to a community of end-recipients.

The computing device 102 includes the data store 104, the processor 106, the media search component 108, the media extracting component 109 and the concatenating component 110 communicatively coupled via the communication bus 105. The computing device 102 further includes a media index component 208, a publishing component 210 and an audio analysis component 212 for generating a multimedia message.

The media index component 208 is configured to index media content portions of a set of media content portions according to a set of criteria. For example, the media index component 208 can index the portions of media content according to words spoken, or phrases spoken within media content portions. For example, if the phrase “It is all good” is identified in a set of media content such as a video and/or an audio recording and extracted by the media extracting component 109, then the media index component 208 can store the portion of the media content with a tag or metadata that identifies the portion extracted as the phrase “It is all good.”

The media index component 208 is configured to index a set of media content (e.g., videos and audio content) that are stored at the data store 104 and/or the data store 206, and store an index of media content portions within the data stores. In one embodiment, the media index component 208 indexes the media content entirely based on a particular video or audio that is selected for extraction by the media extracting component 109. Particular media content, such as particular movie, song, and the like, can indexed according to a classification criteria of the particular media content. For example, classification criteria can include a theme, genre, actor, actress, time period or date range, musician, author, rating, age range, voice tone, and the like. The computer device 102 can receive media content from the client device 202 for indexing by the media index component 208, and/or index media content stored to predefine categories of media content and/or media content portions. In addition, the media index component 208 is configured to index portions of media content that are extracted. The media indexing component 208 can tag or associate metadata to each of the portions as well as the media content as a whole. The tag or metadata can includes any data related to the classification of the media content or portions related to the media content, as well as words, phrases or images pre-associated with the media content, which includes video, audio and/or video and audio pre-associated with one another in each portion extracted, for example.

The publishing component 210 is configured to publish, via the network 203 and/or a networked device or the client device 202, the set of media content portions according to the indexing of the media content portions in an index of the data store 104. The media content portions can be published irrespective of physical storage location, or, in other words, regardless of whether the portions are stored at the client device 202, computing device 102, and/or at the network 203, for example, with words or phrases associated with respective media content portions of the set of media content portions, and/or published based on the metadata or a tag that the media content portions are indexed with. For example, a media content portion indexed according to the phrase “Put 'em up,” can be published as the phrase “Put 'em up” as well as each individual word or smaller phrase with a phrase, such as “put,” or “put 'em.” Additionally or alternatively, the media content portions can be published according to the classifications that the portions are indexed, such as the media content portion being extracted from a Western, as being spoken by the actor Clint Eastwood, being filmed during 1970's, being rated R, and/or other metadata or tag associated with the media content and/or the portions extracted from the media content.

In addition, the publishing component 210 is configured to publish one or more of the computer executable components (e.g., the components of the computer device 102) for download to the client device 202, such as a mobile device via the network 203. The publishing component 210 of the computer device 102 is configured to publish the components to a network for processing on the client device 202, for example. In addition, the message generated by the computing device 102 and/or the client device 202 is published by the publishing component to a network for storage and/or communication to any other networked device. For example, a multimedia message generated by the computing device 102 can include the media content portion with “Put 'em up” as audio content pre-associated with the video content portion extracted from a Clint Eastwood, as well as a concatenated portion thereto with video having pre-associated audio content of “I'll be comin for you,” as stated by the actor William Dafoe in the video “Streets of Fire.” The publishing component 210 is operable to publish the multimedia message including the video portions and audio portions via the network 203 for play as a single video and audio message joined together.

The audio analysis component 212 is configured to analyze audio content of the set of media content and determine portions of the audio content that correspond to the set of words or phrases of the set of inputs. For example, the computing device 102 is operable to receive a set of inputs corresponding to words or phrases for a message, and, based on a word or phrase in the set of inputs, the audio analysis component 212 can analyze the media content for portions within media content having a matching word or phrase in the audio content of the media content. The media extracting component 109 can receive then extract the portions with the matching word or phrase in the media content (e.g., video, and/or audio) to obtain a media content portion that has audio that includes the word or phrase. The media content portion, for example, can be a video segment with an actor saying the word or phrase, for example, as well as a song, speech, musical, etc.

The audio analysis component 212, for example, can identify information meaning from audio signals for analysis, classification, storage, retrieval, synthesis, etc. In one embodiment, the audio analysis component 212 recognizes words or phrases within a set of media content, such as by performing a sound analysis on the spectral content of the media content. Sound analysis, for example, can include the Fast Fourier Transform (FFT), Time-Based Fast Fourier Transform (TFFT) and/or the like tools. The audio analysis component 212 is operable to produce audio files extracted from the media content, and analyze characteristics of the audio at any point in time, and/or as entire audio. The audio analysis component 212 can then generate a graph over the duration of a portion of the audio content and/or the entire sequence of an audio recording that can be pre-associated with and/or not pre-associated with video or other media content. The media extracting component 109 can thus extract portions of the media content based on the output of the audio analysis component 212, such as part of the set of predetermined criteria upon which the extractions can be based.

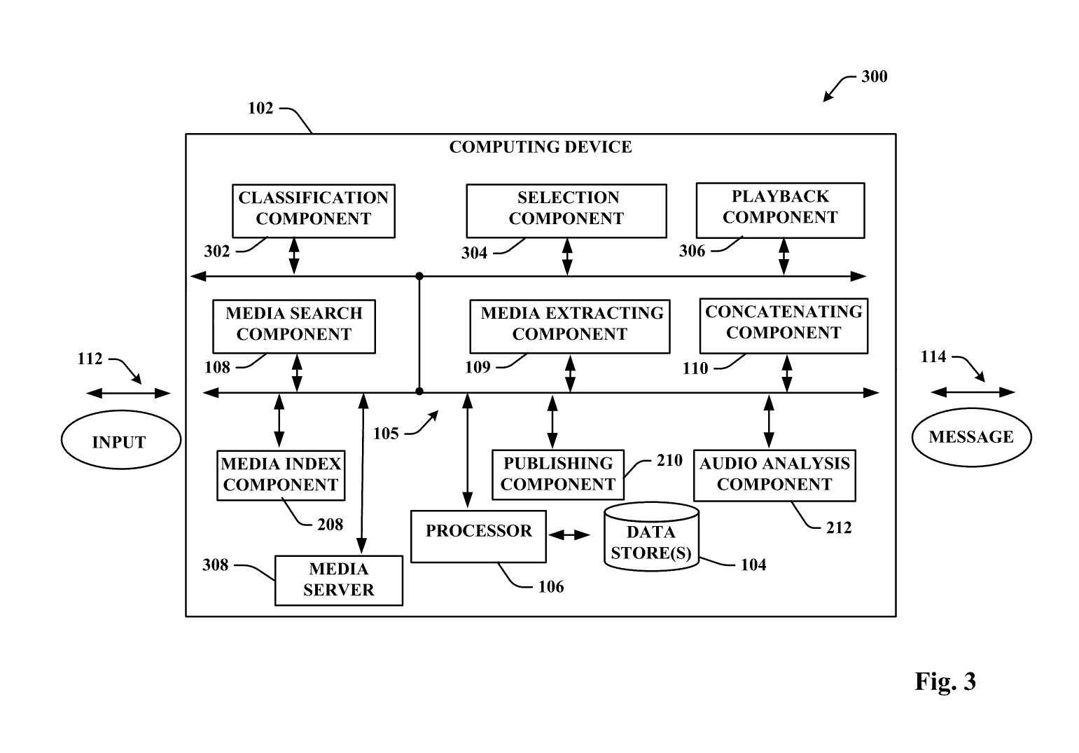

Referring now to FIG. 3, illustrated is a system 300 in accordance with various embodiments described herein. The system 300 comprises the computing device 102. The computing device 102 includes the data store 104, the processor 106, the media search component 108, the media extracting component 109, the concatenating component 110, the media index component 208, the publishing component 210 and the audio analysis component 212 communicatively coupled via the communication bus 105. The computing device 102 further includes a classification component 302, a selection component 304 and a playback component 306 for generating a multimedia message.

The classification component 302 is configured to classify the set of media content according to a set of classifications. For example, the classification of the set of media content can be based on a set of themes (e.g., spirituality, romance, autobiography, etc.), a set of media ratings (e.g. G, PG, R), a set of actors or actresses (e.g., John Wayne, Kate Hudson), a set of song artists (e.g., Bob Dylan), a set of titles, a set of date ranges and/or any other like identifying characteristic of media content. In one embodiment, the classification component 302 communicates classification settings and/or data about the type of media content desired to the media extraction component 109, which then extracts portions from the media content based on the set of classifications as well as the set of words or phrases received as input.

In another embodiment, the classification component classifies media content stored in the data store 104 based on the set of classifications discussed above. Portions of the media content are extracted and can then be further classified according to additional criteria, such as voice tone, gender, race, emotion, age range, look and/or other characteristics of the video and/or audio, which could be suitable for a user to select when formulating a multimedia message 114 with the computing device 102. The classified portions of media content can be tagged or attributed with metadata that is associated with each portion within the data store 104, as well as with the message 114 before and after the message is communicated.

The selection component 304 is configured to generate a set of predetermined selections such as selection options that include a set of textual words or phrases that correspond to at least one media content portion of the set of media content portions. The selection component 304 is configured to receive the set of predetermined selections as the set of inputs and communicate the portions of media content corresponding to selections for generation of the multimedia message. For example, a selection can be a word or phrase such as “I love you.” Each word or the entire phrase can correspond to media content portions that make up “I love you”, thus generating a multimedia message that communicates “I love you.”

In addition or alternatively, the selections could be the portions of media content themselves, in which more than one media content portions corresponds to a given word or phrase. Consequently, various media content portions can generated by the selection component 304 for a given word or phrase, in which selections can be received to associate a media content portion with any number of words or phrases. For example, if various media content portions for the word “love” are presented, a selection of the media content portion can be received and processed to associate the media content portion to the word “love” in the multimedia message. The multimedia message can then be generated to have various media content portions from different media content based on selections received, which are predetermined based on the word and/or selection options for various media content portions associated with a word or phrase. The selection component 304 is configured to then communicate the media content portions as selections to be inserted into the multimedia message. The selections, for example, can be received via any number of graphical user interface controls, such as by drag and drop, links, drop down menus, and/or any other graphical user interface control.

A media server 308 is configured to manage the various media content that is searched and indexed, as well as assist in publishing components of the computer device 102 to a network for download on a mobile device or other device. The media server 308 is thus configured to facilitate a sharing of media content of the set of data stores to communicate the respective media content portions of the media content via a network irrespective of physical storage location, and to manage storing of an index of different media content portions having video content and audio content based on associations to words or phrases including the set of words or phrases, and/or selections received at the selection component 304.

The computing device 102 further includes the playback component 306 that is configured to generate a preview of the multimedia message including a rendering of selected media content portions of the set of media content portions in a concatenated video stream at a display component (not shown), such as a touch screen display or other display device. For example, in response to receiving a playback input, the playback component 306 can provide a preview of the message generated with any number of media content portions that make up the phrase “I love you.” The message can then be further edited or modified to a user's satisfaction before sending based on a preview of the multimedia message.

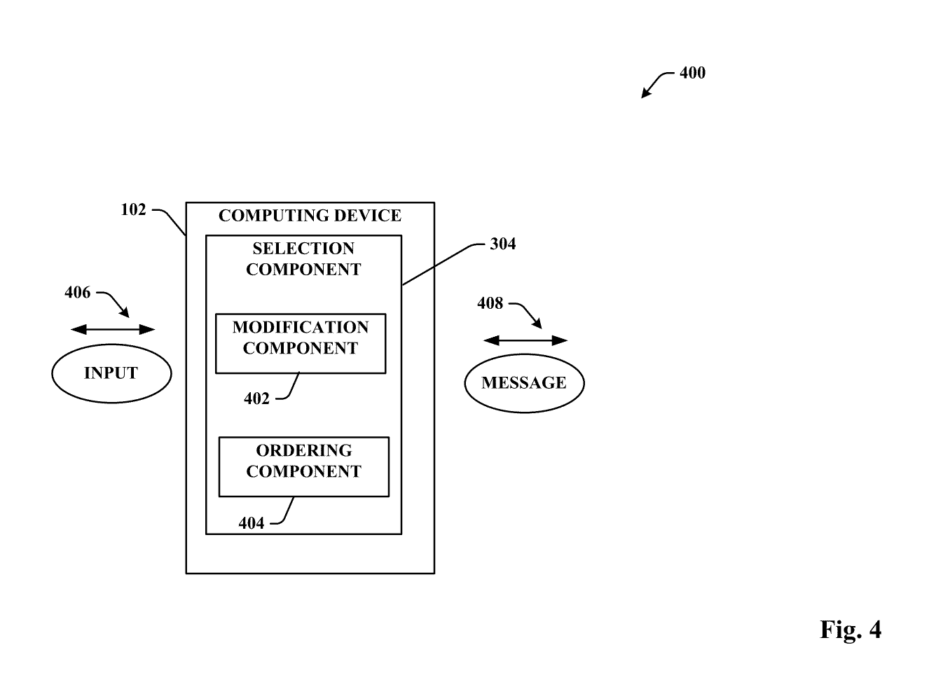

Referring to FIG. 4, illustrated is a system 400 that generates messages with various forms of media content from a set of inputs, such as text, voice, and/or predetermined input selections that can be different or the same as the media content of the message in accordance with various embodiments herein. The system 700 is configured to receive a set of inputs 406 and communicate, transmit or output a message 408. The set of inputs 406 comprise a text message, a voice message, a predetermined selection and/or an image, such as a text-based image or other digital image, for example.

The selection component 304 of the computing device 102 further includes a modification component 402 and an ordering component 404. The modification component 402 is configured to modify media content portions of the message 408. The modification component 402, for example, is operable to modify one or more media content portions such as a video clip and/or an audio clip of a set of media content portions that corresponds to a word or phrase of the set of words or phrases communicated via the input 406. In one embodiment, the modification component 402 can modify by replacement of the media content portions with a different media content portion to correspond with the word or phrase identified in the input 406. For example, the message generated 408 from the input 406 can include media content portions, such as text phrases or words (e.g., overlaying or proximately located to each corresponding media content portion), video clips, images and/or audio content portions. The modification component 402 is configured to modify the message 408 with a new word or phrase to replace an existing word or phrase in the message, and, in turn, replace a corresponding video clip.

Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the selection component 304 can be provided a set of media content portions that correspond to a word, phrase and/or image of an input for generating the message 408 and/or to be part of a group of media content portions corresponding with a particular word, phrase and/or image.

In another embodiment, the selection component 304 is further configured to replace a media content portion that corresponds to the word or phrase with a different video content portion that corresponds to the word or phrase, and/or also replace, in a slide reel view, a media content portion that corresponds to the word or phrase with another media content portion that corresponds to another word or phrase of the set of words or phrases.

The selection component 304 includes an ordering component 404 that is configured to modify and/or determine a predefined order of the set of media content portions based on a received modification input for a modified predefined order, in which can be communicated with the set of words or phrases in the modified predefined order. For example, a message that is generated with media content portions to be played in multimedia message such as a video and/or audio message can be organized in a predefined order that is the order in which the input is provided or received by the message component 110. The ordering component 404 is thus configured to redefine the predefined order by either drop, drag, and/or some other ordering input that rearranges the media content portions.

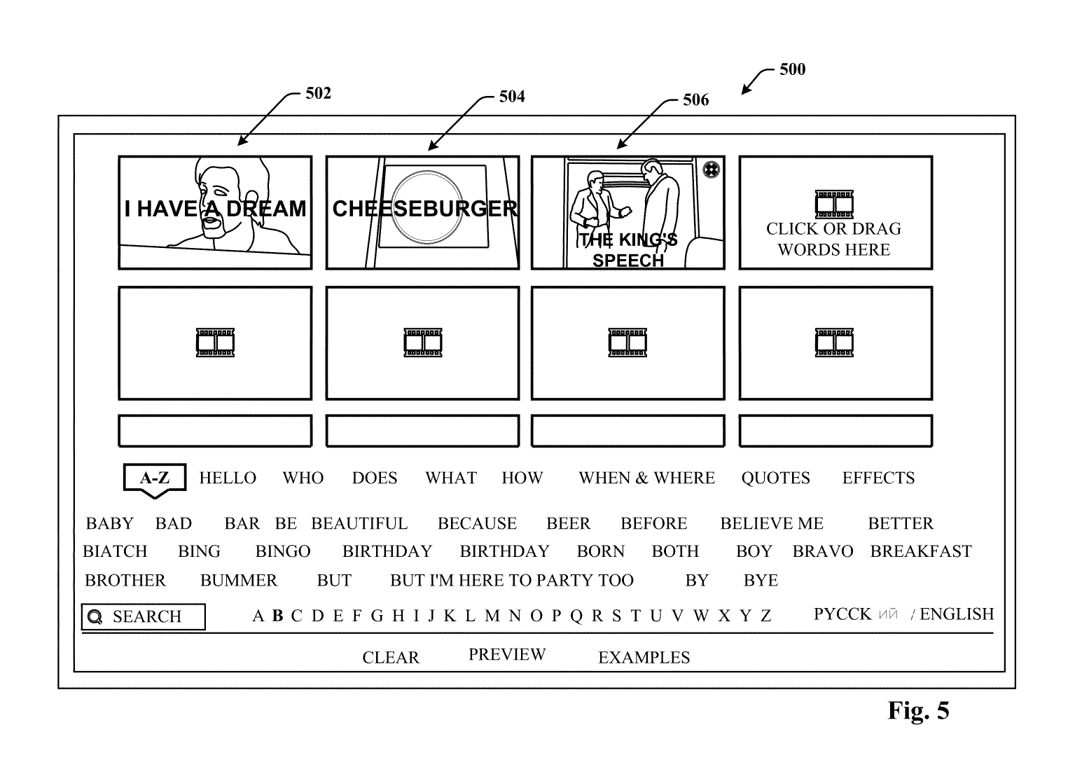

FIG. 5 illustrates one example of a view pane 500 having predetermined text inputs that can be searched for and/or selected that have corresponding media content portions. Example view panes described herein are representative examples of aspects disclosed of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration. The text inputs, for example, can be provided in a search component in order to find words or phrases with corresponding video portions. In addition or alternatively, for example, the text inputs could be words or phrases to search media content to correspond to the words or phrases according to a set of predetermined criteria, as discussed herein.

In one example of the view pane 500, phrases, words and/or images can be dragged into the slide reel. The words or phrases can be classified according to classification criteria by the classification component 302 and/or an index component 208 and according to media content corresponding to the phrases, words, and/or images that meet a set of classification criteria, such as for popular videos (e.g., movies). A thumbnail component (not shown) can generate a display of a representation of each media content portion (e.g., video clips) with an indicator of the type of message the media content portion expresses. The words or phrases and associated media content portions can be indexed by the media index component 208. For example, a media content portion 502 has the phrase “I HAVE A DREAM,” is expressed by a portion of the movie “You Don't Mess with the Zohan.” The thumbnail component is configured to generated metadata or information related to the media content portion when an input for example, such as a hovering input or user interface control is received. For example, the media content portion 506 displays metadata that the media content portion is derived from the movie “The Kings Speech,” in which the phrase “BEER” is spoken in a lucrative office setting. In addition, the media content portion 504 includes “CHEESEBURGER” that is expressed by a portion or segment of the movie “Cloudy with a Chance of Meatballs.”

Additionally, the viewing pane 500 can include various classifications of various media content portions, such as alphabetical orderings, popular phrases, type of content or categories of words or phrases, quotes, effects and others, which can include sound effects, stage effects, video effects, dramatic actions, expressions, shouts, etc., which can be composed and transmitted via a mobile device or other device in a text message, multimedia message and/or other type messages.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure.

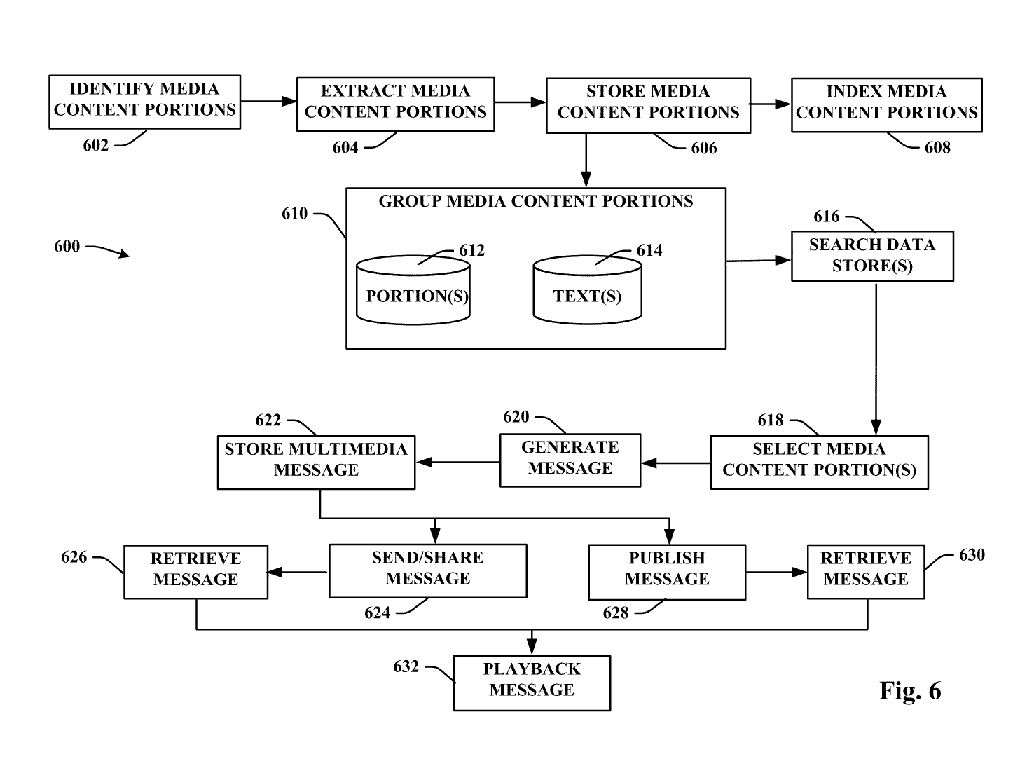

Referring to FIG. 6, illustrated is an exemplary system flow 600 in accordance with embodiments described in this disclosure. The system 600 identifies media content portions at 602 based on a set of inputs, such voice inputs, digital typed inputs, text inputs and/or other inputs to generate a message with words or phrases, such as a selection of predefined words or phrases.

At 604 media content portions of media content are extracted according to a set of predetermined criteria. For example, words or phrases of the text input can be associated with words and phrases of video and/or audio content and portions of media content corresponding to the words or phrases can be extracted. For example, the system is configured to edit, slice, portion and/or segment a video/audio for words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In addition or alternatively, the media component 120 is configured to dynamically, in real time generate corresponding video scenes, video/audio clips, portions and/or segments from an indexed set of videos stored in one or more data store(s).

At 606, media content portions extracted are stored in one or more data store(s), such as a data store at a client device, a server, or a host device via network. At 608 the media content portions are indexed. For example, a database index can be generated that is a data structure for improving the speed of media content retrieval operations on an index such as a database table. Indexes can be created with the media content portions, classifications, and corresponding words or phrases using one or more columns of a database table, providing the basis for both rapid random lookups and efficient access of ordered records.

At 610, media content portions can be grouped and/or classified, for example, in a media portions database 612 and/or words or phrases can be stored in a text data store 614 that corresponds to each of the media portions. At 616, data store(s) can be searched in response to a query for media content portions corresponding to the query terms. At 618, a selection input is received that selects media content portion(s) generated from the query.

At 620, a set of media content portions that correspond to the words or phrases of text according to a set of predetermined criteria and/or based on a set of user defined preferences/classifications is concatenated together to form a multimedia message. As stated above, text inputs can be selected, communicated and/or generated onsite via a web interface. The message can be dynamically generated as a multimedia message that corresponds to the words or phrases of the text message of the text input. The portions of media content can correspond to the words or phrases according to predefined/predetermined criteria, for example, based on audio that matches each word or phrase of the text inputs, as well as classification criteria.

In one embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text. The predetermined criteria, for example, can include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message.

Further, the message of media content portions (e.g., portions of video and/or audio that are pre-associated with video to or not pre-associated) can be generated in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie.

At 622, the multimedia message that is generated can be shared, published and/or stored irrespective of location, such as on a client device, a host device, a network, and the like. At 624 the message can be communicated or shared where the message is transmitted to a recipient, such as via a text multimedia message or other electronic means. At 626, the message can be retrieved and played back at 632 by a user and/or a recipient of the message. At 628, message can also be published via a network, and retrieved at 630 for playback at 632 by any user of the system, and/or device having a network connection.

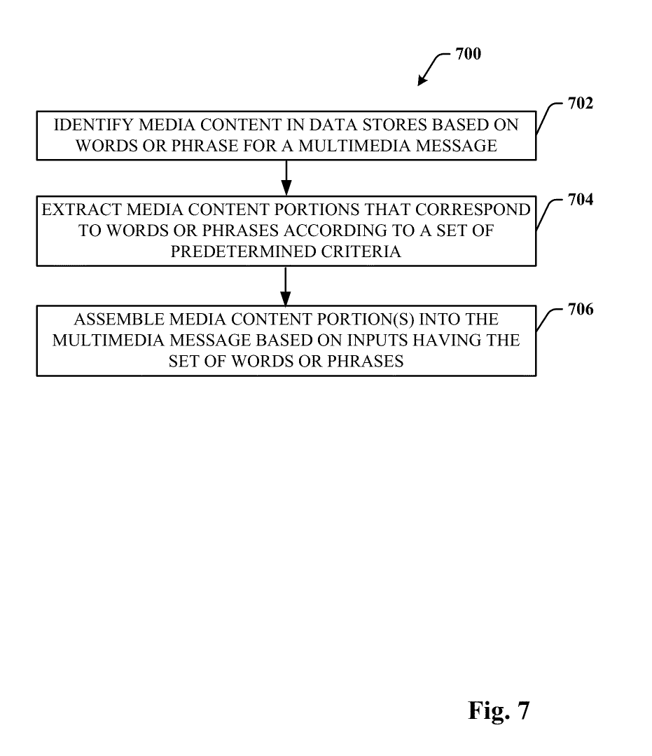

An example methodology 700 for implementing a method for a messaging system is illustrated in FIG. 7 in accordance with aspects described herein. The method 700, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 702, the method initiates with identifying, by a system including at least one processor, a set of media content such as video content and audio content in a set of data stores irrespective of location based on a set of words or phrases for a multimedia message.

At 704, media content portions are extracted such as a set of video content portions and audio content portions, which correspond to the set of words or phrases according to a set of predetermined criteria. The predetermined criteria, for example, can be at least one classification of the set of classifications and a matching of media content portions of the set of media content portions from the set of media content with the set of words or phrases. The predetermined criteria can comprise a matching audio clip within the set of media content portions that matches a word or phrase of the set of words or phrases, one or more of a matching classification for the set of video content portions according to a set of predefined classifications, and/or a matching action for the set video content portions with the set of words or phrases.

At 706, the method 700 continues with assembling at least one video content portion and at least one audio content portion of the set of media content portions into the multimedia message based on a set of inputs having the set of words or phrases. For example, the order that the inputs are received can be the order in which the multimedia message is generated as well as matching words or phrases from the set of inputs.

In one embodiment, the method 700 includes dividing the set of video content and audio content into video content portions and audio content portions according to at least one of words, phrases, or images determined to be included in the video content portions or the audio content portions. For example, entire video and audio content can be divided into words, phrases and/or images for selection of various media content portions to be inserted into the message. In addition, a number of classification criteria can also be accounted for in the dividing, which enables predefined portions to be indexed and further selected for one or more multimedia messages.

In another embodiment, the method can classify media content portions according to a set of predefined classifications that includes at least one of a set of themes, a set of song artists, a set of actors, a set of album titles, a set of media ratings of the set of video content and audio content, voice tone, or a set of time periods.

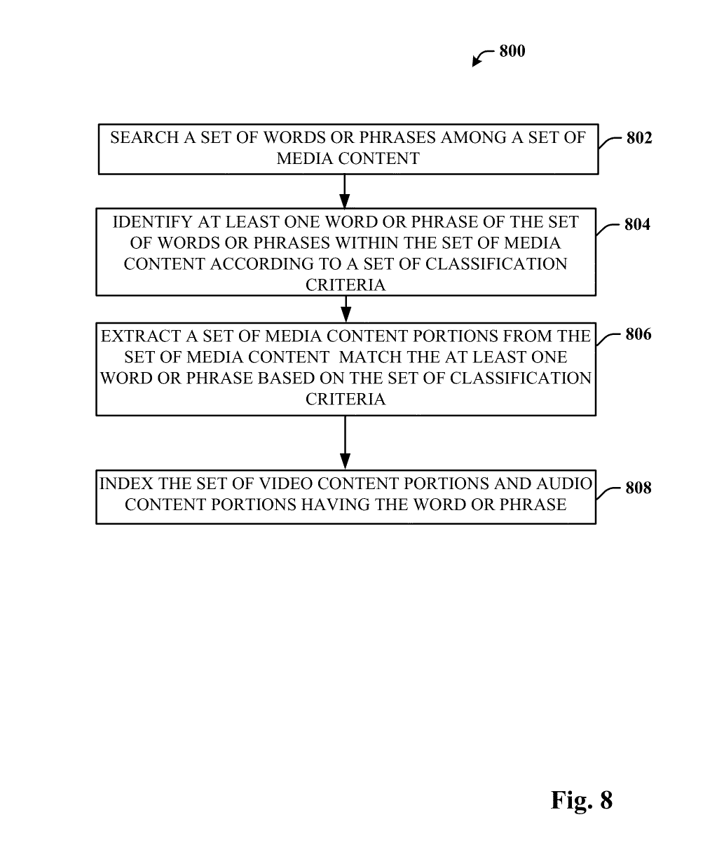

An example methodology 800 for implementing a method for a system such as a multimedia system for media content is illustrated in FIG. 8. The method 800, for example, provides for a system to evaluate various media content inputs and generate a sequence of media content portions that correspond to words, phrases or images of the inputs. At 802, the method initiates with searching for a set of words or phrases among a set of media content such as video content and audio content in a set of data stores.

At 804, at least one word or phrase of the set of words or phrases are identified within the set of media content searched according to a set of classification criteria. The classification criteria can be, for example, an actor, an actress, a theme, a genre, a rating of a film, a target audience, a date range or time period, and/or the like.

At 806, a set of media content portions are extracted having audio content that matches the word or phrase based on the set of classification criteria. At 808, the set of media content portions are indexed having the at least one word or phrase of the set of words or phrases that are pre-associated with video content and audio content in the set of data stores according to at least one of the at least one word or phrase, or the classification criteria.

The method can further include concatenating at least two video content portions or audio content portions of the set of video content portions and audio content portions into the multimedia message based on a set of selection inputs, and communicating the set of video content portions and audio content portions as selections to be inserted into the multimedia message.

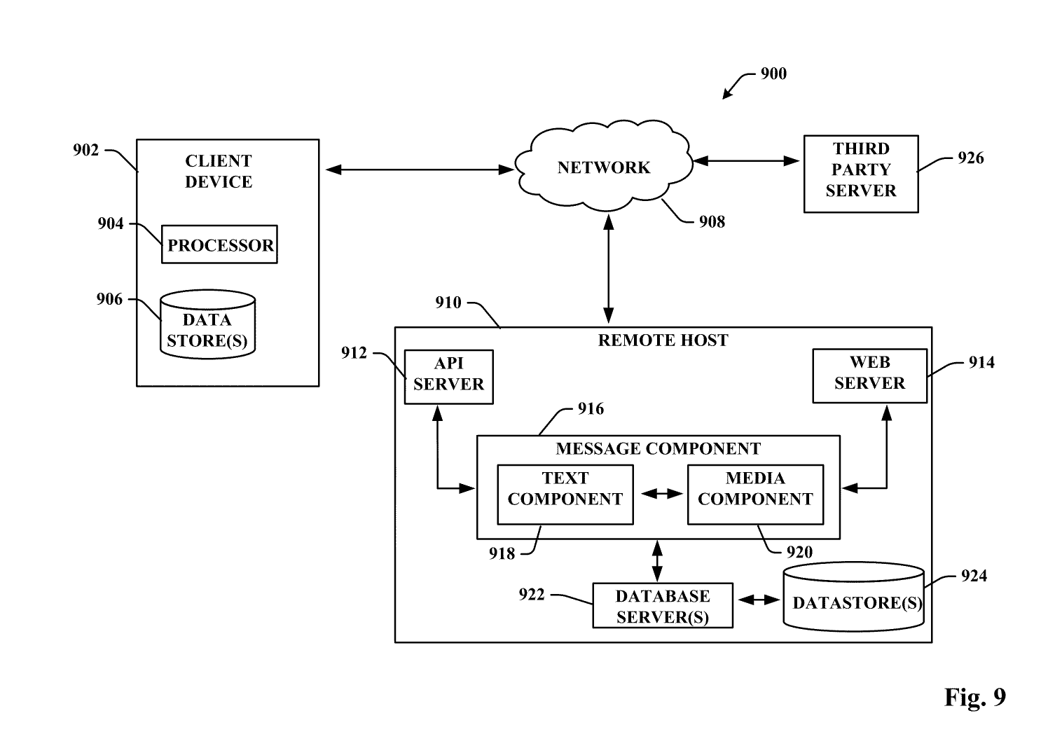

Referring to FIG. 9, illustrated is an example system 900 for generating one or more messages having video and/or audio content that corresponds to a set of text inputs in accordance with various aspects described herein. The system 900 is operable as a networked messaging system that communicates multi-media messages via a computing device, such as a mobile device or mobile phone. The system 900 includes a client device 902 that includes a computing device, a mobile device and/or a mobile phone that is operable to communicate one or more message to other devices via an electronic digital message (e.g., a text message, a multimedia text message and the like). The client device 902 includes a processor 904 and at least one data store 906 that processes and stores portions of media content such as video clips of a video comprising multiple video clips, portions of videos and/or portions of audio content and image content that is associated with the videos. The video clips, video segments and/or portions of videos can also include song segments, sound bites, and/or other media content such as animated scenes, for example. The clips, portions or segments of media content stored can be stored in an external data store, such as a data store 924, in which the media content can include portions of songs, speeches, and/or portions of any audio content.

The client device 902 is configured to communicate to other client devices (not shown) and to a remote host 910 via a network 908. The client device 902, for example, can communicate a set of text inputs, such as typed text, audio or some other input that generates a digital typed message having alphabetic, numeric and/or alphanumeric symbols for a message. For example, the client device 902 can communicate via a Short Message Service (SMS) is a text messaging service component of phone, web, or mobile communication systems, using standardized communications protocols that allow the exchange of short text messages between fixed line and/or mobile devices.

The client device 902 is operable to communicate multimedia content via the network 908, which can include a cellular network, a wide area network, local area network and other networks. The network 908 can also include a cloud network that enables the delivery of computing and/or storage capacity as a service to a community of end-recipients that entrusts services with a user's data, software and computation over a network. For example, the client device 902 can include multiple client devices, in which end users access cloud-based applications through a web browser or a light-weight desktop or mobile app while software and user's data can stored on servers at a remote location.

The system 900 includes the remote host that is communicatively connected to one or more servers and/or client devices via the network 908 for receiving user input and communicating the media content. A third party server 926, for example, can include different software applications or modules that may host various forms of media content 902 for a user to view, copy and/or purchase rights to. The third party server 926 can communicate various forms of media content to the client device 902 and/or remote host 910 via the network 908, for example, or via a different communication link (e.g., wireless connection, wired connection, etc.). In addition, the client device 902 can also enable viewing, interacting or be configured to communicate input related to the media content. For example, the client device 902 can have a web client that is also connected to the network 908. The web client can assist in displaying a web page that has media content, such as a movie or file for a user to review, purchase, rent, etc. Example embodiments can include the remote host 910 operable as networked system via a client machine or device that is connected to the network 908 and/or as an application platform system. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The network 908 is communicatively connected to the remote host 910, which is operable as a networked host to provide, generate and/or enable message generation on the network 908 and/or the client device 902. The third party server 926, client device 902 and/or other client device, for example can requests various system functions by calling application programming interfaces (APIs) residing on an API server 912 of the remote host 910 for invoking a particular set of rules (code) and specifications that various computer programs interpret to communicate with each other. The API server 912 and a web server 914 serves as an interface between different software programs, the client machines, third party servers and other devices and facilitates their interaction with a message component 916 and various components having applications for hardware and/or software. A database server 922 is operatively coupled to one or more data stores 924, and includes data related to various described components and systems described herein, such as portions, segments and/or clips of media content that includes video content, imagery content, and/or audio content that can be indexed, stored and classified to correspond with a set of text inputs.

The message component 916, for example, is configured to generate a message such as a multimedia message having a set of media content portions. The message component 916 is communicatively coupled to and/or includes a text component 918 and a media component 920 that operate to convert a set of text inputs that represent or generate a set of words or phrases to be communicated by the client device 902 and/or the third party server 926. For example, the set of text inputs can include voice inputs, digital typed inputs, and/or other inputs that generate a message with words or phrases, such as a selection of predefined words or phrases. For example, text input can be received by the text component 918 and communicatively coupled to the media component 920.

The media component 920, in response to a set of text inputs received at the text component 918 is configured to generate a correspondence of a set of media content portions with the set of text inputs. For example, words or phrases of the text input can be associated with words and phrases of a video. In addition or alternatively, the media component 920 is configured to dynamically, in real time generate corresponding video scenes, video/audio clips, portions and/or segments from an indexed set of videos stored in the data store 924, data store 906, and/or the third party server 926.

The media component 920 is configured to edit, slice, portion and/or segment a video/audio for words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In one example, a user, such as a user that is hearing impaired, can generate a sequence of video clips (e.g., scenes, segments, portions, etc.) from famous movies or a set of stored movies of a data store without the user hearing or having knowledge of the audio content. Based on the set of text inputs the user provides or selects, portions of video movies/audio can be provided by the media component 924 for the user to combine into a concatenated message. The message can then be communicated by being played with the sequence of words or phrases of the textual input by being transmitted to another device, and/or stored for future communication. The media component 920 therefore enables more creative expressions of messaging and communication among devices.

In another example, a client device 902 or other party generates the message via the network 908 at the remote host 910, and then the remote host 910 communicates the message created to the client device 902, third party server 926 and/or another client for further communication from the client device 902. In addition or alternatively, the message can be generated directly at the client via an application of the remote host 910. The messages generated can span the imagination, and correspond to phrases or words according to actions or images that make up portions of media content or video content. For example, an angry gesture can be identified via the text input and a gesture corresponding to the identified angry gesture can be identified within the set of media content portions, and, in turn, placed within the message, such as a video message with scenes or clips corresponding to the text input. A middle finger being given by an actor in a famous movie, for example, could correspond to certain curse words or phrases within the set of text inputs received at the text component 918, and then concatenated into the message by the message component 916 to correspond to the emoticon, icon, or text based graphic as part of the message made of corresponding movie scenes (i.e., portions, segments, and/or clips of video).

In one embodiment, the media component 920 is configured to generate a set of media content portions that correspond to the words or phrases of text according to a set of predetermined criteria and/or based on a set of user defined preferences/classifications. For example, the media component 920 can include a set of logic (e.g., rule based logic or other reasoning processes) that is implemented with an artificial intelligence engine (not shown) such as via a rule based logic, fuzzy logic, probabilistic, statistical reasoning, classifiers, neural networks and/or other computing based platforms. The media component 920 is configured to identify and organize portions of video and/or audio content for generation of multimedia messages based on textual inputs. As stated above, the text inputs can be selected, communicated and/or generated onsite via a web interface of the remote host 910. The message component 916 responds to the text input by dynamically generated a multimedia message that corresponds to the words or phrases of the text message of the text input. The portions of media content can correspond to the words or phrases according to predefined criteria, for example, based on audio that matches each word or phrase of the text inputs.

In one embodiment, words that have little or less meaning, such as articles (e.g., the, a, an, etc.) can be set by a user preference to be ignored, altered to a different article and/or incorporated with the word or phrase in a media content portion that corresponds to the input word or phrase received. If particular words are ignored, the media component 916 can still generate the message according to other word types, such as verbs, nouns, adjectives, adverbs, prepositions, etc. and still create the multimedia message from the text inputted for the message. In another embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text.

In another embodiment, a text message received via text input to the text component 918 is also configured to receive emoticons, text-based images, such as a colon and a closed parenthesis for a smiley face or any other text-based image or graphic. The media component 920 is configured to identify the text-based image and generate a video scene that corresponds. For example, a smiley face received as a colon and a closed parenthesis could initiate the media component 916 to generate a corresponding image of video, such as a smile from the Cheshire cat in the movie “Alice and Wonderland.”

In another embodiment, the message component 916 is further configured to generate a voice overlay via a voice overlay component (not shown). The text component 918 receives the text input and is further configured to dynamically generate a voice that corresponds to the text, which is one example of a user preference that can be set to operate along with the operations discussed above. The user preference can provide for a female, male, young, old, and/or tone of voice for the voice overlay, which is generated to accompany the set of media content assembled as part of the message. For example, a text input could be the following: “How are you? It's a beautiful morning!” In response, the message component 910 is operable to generate a message with the text message, with a voice overlay in a chosen voice, and/or the sequence of video/audio content that corresponds to each word or phrase of the message. In addition, the audio of a video could be muted or overlap the voice overlay for a duet vocal, and video message. Likewise the video could be blocked to only generate the audio of the corresponding video portion.

As stated above, the media component 920 generates a message of media content portions that correspond to text input according to a set of predetermined criteria. The predetermined criteria, for example, include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message that not only matches the word or phrase the portion corresponds to, but also includes grunts, onomatopoeias, conjunctions or dialects of a word such as “y'all” for “you all,” if one is southern born.

Further, the media component 920 is configured to generate a message of media content portions (e.g., portions of video and/or audio that accompanies or does not accompany video), in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie. Thus, a user can predefine preference for the message component 916 to dynamically generate videos on demand, in real time, dynamically or in a predetermined classification according to the set of video content portions that correspond to words or phrases of a text message.

In another embodiment, the message component 910 is configured to generate media content portions that include video portions of a video mixed with audio portions of another movie that both correspond to words or phrases in a text message. For example, the media component 916 is configured to generate video scenes that correspond to a word or phrase of a text message, in which the audio of the movie can correspond or some other content correspond to the textual word or phrase. While one scene or segment of an audio and/or video component can be generated to correspond with the phrase or word, any number of scenes, segments or audio portions can also be generated and mixed so that a video saying the word “Hello” by the actor John Wayne can be replaced with audio from another movie with the same audio, but different video, such as from Jim Caney. As such, the audio of one video portion can be replaced with the audio of another video portion and selected to represent the particular word or phrase from the textual input for the multimedia message.

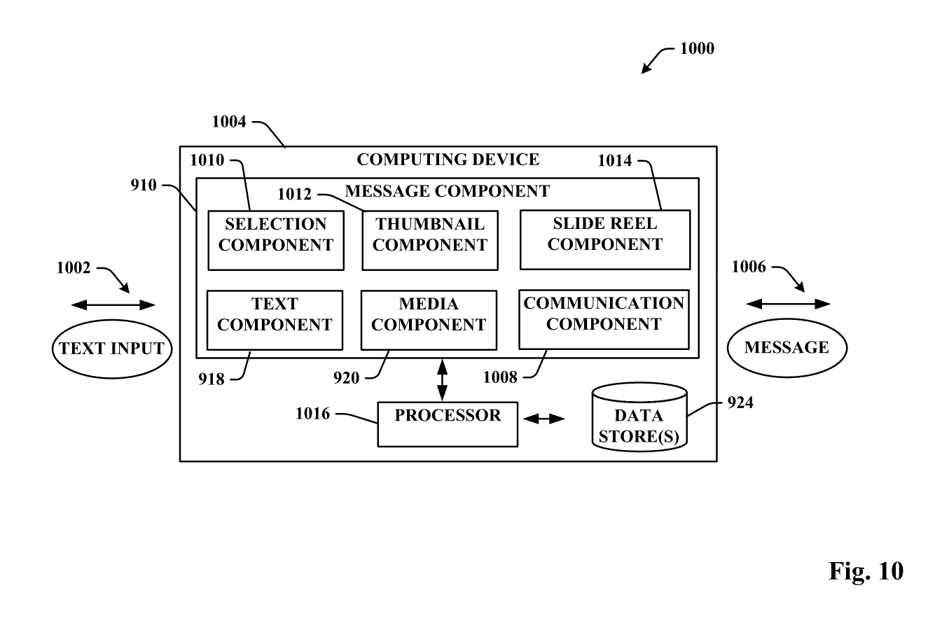

Referring now to FIG. 10, illustrated is a system 1000 that generates a message having various media content portions to correspond to a text message input in accordance with various embodiments disclosed in this disclosure. The system 1000 includes a computing device 1004 that can comprise a remote device, a personal computing device, a mobile device, and any other processing device. The computing device 1004 includes the message component 910, a processor 1016 and the data store 924. The computing device 1004 is configured to receive a text input 1002 via a voice input, a typed text input and/or via a selection of a textual word or phrase in the data store 924.

The message component 910 includes the text component 918 that is configured to receive the set of text inputs 1002 and to generate a set of words or phrases of a message 1006. The message 1006 includes a set of video images or video scenes, clips, portions segments, etc. that correspond to the text input 1002. The computing device 1004 is configured to create the message 1006 as a multimedia message that has scenes or segments from different videos or movies that enact and/or have audio content that reflects, is indicative of, or corresponds to the words or phrases of the text input 1002.

The message component 910 includes the text component 918 and the media component 920, which is configured to generate a set of media content portions (e.g., video scenes, and/or audio portions) of a media content that corresponds to words or phrases of the text input 1002. The message component 910 further includes a communication component 1008, a selection component 1010, a thumbnail component 1012 and a slide reel component 1014. The communication component 1008 is configured to communicate the message 1006 to a different device via a network, such as a mobile device or another computing device. The communication component 1008 can include a transceiver, for example, or any other communicating component for transmitting and/or receiving multimedia messages, video messages, text message, audio messages and/or any electronic message to a user.

The selection component 1010 is configured to receive a selection of a media content portion of a plurality of media content portions associated with a word or phrase of the set of words or phrases to include in the set of media content portions. Based on the received selection, the thumbnail component 1012 is configured to generate a set of representative images that represent the set of media content portions corresponding to the set of words or phrases. The representative images can include thumbnail images such as still scene shots, and/or metadata representative of and associated with each media content portions generated by the media component 920 and/or that is selected by a composer of the message. Each thumbnail image can represent a word or phrase of the text message and of a word, phrase, image, and/or action of the media content portion represented. The slide reel component 1014 is configured to present the set of representative images of the thumbnail component 1012 in a selected order, in which the message 1006 is to be viewed by a recipient of the message. In one example, the message is composed along a slide reel that is generated by the slide reel component 1014 for the selections and the order to be defined. The selections received populate the slide reel in a concatenated sequence of video and/or audio content portions, in which the message 1006 will be composed. The order can be altered and the selected video/audio content portions assigned to each slide or reel can be altered. For example, if a video/audio content portion expressing the word “dog” is desired to be changed to “cat,” the thumbnail portion representing “dog” can be dragged out and another media content portion representing “cat” can replace the one representing “dog” by being dragged/dropped in the same location in along the slide reel. Further, the slide reel component 1014 is also operate to generate a preview of the concatenated sequence of video and/or audio content portions for a user to view before sending the final composed message.

The selection component 1010 is configured to receive a selection of a media content portion of a plurality of media content portions associated with a word or phrase of the set of words or phrases to include in the set of media content portions. For example, a query term or phrase could be entered to search for video content and/or audio content that includes or expresses the particular word or phrase. Upon receiving one or more results, the message component 910 can receive a selection of the media content, splice or edit the media content portion having the word or phrase selected and represent it as an option to be included within the slide reel, or within another view pane, individually or with a group of other media content portions.

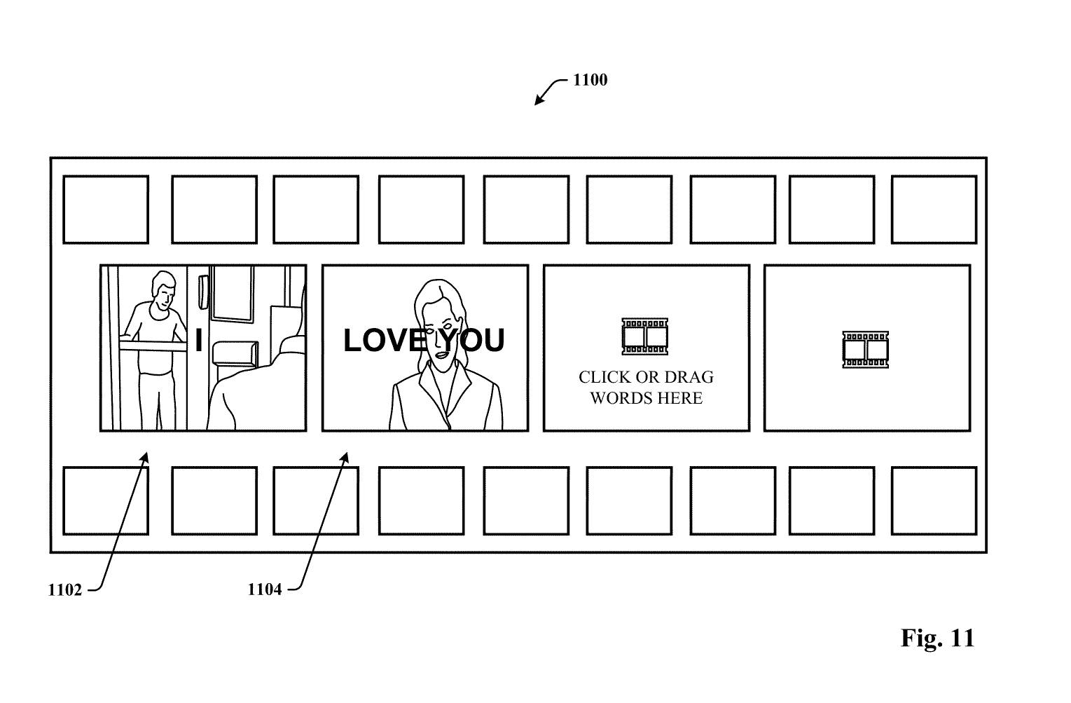

FIG. 11 illustrates one example of a generated slide reel by the slide reel component 1014 having a set of representative images in a selected order. The text words or phrases “I LOVE YOU” are presented as an overlay of each representative image. However, the text can be proximate to or alongside each thumbnail image slide 1102 and/or 1104. In one example, the word “I” is depicted to correspond with a selected media content portion comprising a video scene from a movie with an actor saying the word “I” with a certain tone and reflection, and is previewed in a slide 1102 having a thumbnail image of the video content portion that corresponds to the word “I”. Likewise, the next slide in the concatenated order includes the phrase “LOVE YOU” and corresponds to a set of scenes or a video/audio media content portion from a movie with a different actor of a different context expressing the phrase “LOVE YOU.” In addition, other media content portions could be selected to fill other reels, such as “VERY” and “LITTLE” after the slides 1102 and 1104. In addition, the thumbnail images can be other types of image data or representative data of the media content portions corresponding to a word, phrase and/or an image received, as well as include metadata that pertains to the media content portion. For example, video clips can be represented with thumbnail images and/or other data such as metadata that details properties, classification criteria, information about actors, filmed date, genre, rating, themes, awards received, and any data pertaining to the particular video that the video clip is cut or sliced from. Other forms of media content portions can also include metadata represented in a thumbnail image or other image such as audio data having information about the song, singer, speech, and/or other vocal expression. Consequently, the video sequence is represented by the thumbnails of the reel 1100, but when communicated is played as a video with audio and/or the textual messages concatenated in a single video. Additionally or alternatively, portions could include only audio, and/or only video, and/or still image portions having audio or not. The text message can be generated with the other media content portions that correspond thereto, and/or without. The text message can be overlaying and/or proximate to as subtitles to the multimedia message.

In some embodiments, the systems (e.g., system 900) and methods disclosed herein are implemented with or via an electronic device that is a computer, a laptop computer, a router, an access point, a media player, a media recorder, an audio player, an audio recorder, a video player, a video recorder, a television, a smart card, a phone, a cellular phone, a smart phone, an electronic organizer, a personal digital assistant (PDA), a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a digital device with at least one tamper-resistant chip, an electronic device associated with an industrial control system, or an embedded computer in a machine.

In some embodiments, a bus further couples the processor to a display controller, a mass memory or some type of computer-readable medium device, a modem or network interface card or adaptor, and an input/output (I/O) controller. The display controller may control, in a conventional manner, a display, which may represent a cathode ray tube (CRT) display, a liquid crystal display (LCD), a plasma display, or other type of suitable display device. Computer-readable medium may include a mass memory magnetic, optical, magneto-optical, tape, and/or other type of machine-readable medium/device for storing information. For example, the computer-readable medium may represent a hard disk, a read-only or writeable optical CD, etc. A network adaptor card such as a modem or network interface card is used to exchange data across the network. The I/O controller controls I/O device(s), which may include one or more keyboards, mouse/trackball or other pointing devices, magnetic and/or optical disk drives, printers, scanners, digital cameras, microphones, etc.

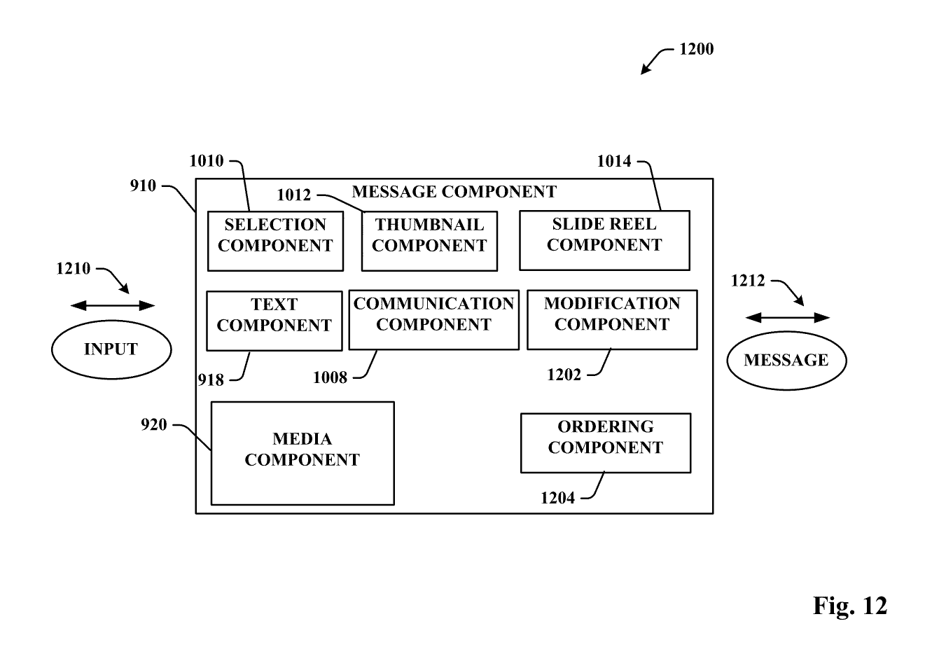

Referring to FIG. 12, illustrated is a system 1200 that generates messages with various forms of media content from a set of inputs, such as text, voice, and/or predetermined input selections that can be different or the same as the media content of the message in accordance with various embodiments herein. The system 1200 includes the message component 910 that is configured to receive a set of inputs 1210 and communicate, transmit or output a message 1212. The set of inputs 1210 comprise a text message, a voice message, a predetermined selection and/or an image, such as a text-based image or other digital image. The message 1212 that is generated by the message component 1212 is operable to convert the input to a message having different forms of media content, such as a set of videos, audio and/or scenes or images of a movie that correspond to the content or phrases and words expressed by the set of inputs 1210.

The message component 910 includes the text component 918, the media component 920, the communication component 1008, the selection component 1010, the thumbnail component 1012, and the slide reel component 1014, which operate similarly as detailed above. The message component 910 further includes a modification component 1202 and an ordering component 1204, and the media component 920 further includes an audio component 1206 and video component 1208. These components integrate as part of the message component or separately in communication to one another to provide an expressive message that is able to be modified creatively and dynamically by a user with a computer device (e.g., a mobile device or the like). The message component 910, for example, is configured to analyze the inputs 1210 received at an electronic device or from an electronic device, such as from a client machine, a third party server, or some other device that enables inputs to be provided from a user. The message component 910 is configured to receive various inputs and analyze the inputs for textual content, voice content and/or indicators of various emotions or actions being expressed with regard to media. For example, a text message may include various marks, letters, and numbers intended to express an emotion, which can be discernible by analyzing a store of other texts, or ways of expressing emotions. Further, the way emotions are expressed in text can change based on cultural language, different punctuations used within different alphabets, for example. The message component 910 thus is configured to translate inputs from one or more users into an image (e.g., an emotion, expression, action, gesture, etc.). The message component 910 is thus operable to discern the different marks, letters, numbers, and punctuation to determine an expressed word, phrase, expression (e.g., an emotion) and/or image from the input, such as from a text or other input 1210 from one or more users in relation to media content, and based on the input generate a message having one or more different types of media content, such as video, audio, text, imagery, etc.

The modification component 1202 is configured to modify media content portions of the message 1212. The modification component 1202, for example, is operable to modify one or more media content portions such as a video clip and/or an audio clip of a set of media content portions that corresponds to a word or phrase of the set of words or phrases communicated via the input 1210. In one embodiment, the modification component 1202 can modify by replacement of the media content portions with a different media content portion to correspond with the word or phrase identified in the input 1210. For example, the message generated 1212 from the input 1210 via the message component 910 can include media content portions, such as text phrases or words (e.g., overlaying or proximately located to each corresponding media content portion), video clips, images and/or audio content portions. If desired, the modification component 1202 can modify the message with a new word or phrase to replace an existing word or phrase in the message, and, in turn, replace a corresponding video clip. Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the message component can be provided a set of media content portions that correspond to a word, phrase and/or image of an input for generating the message 1212 and/or to be part of a group of media content portions corresponding with a particular word, phrase and/or image.

In another embodiment, the modification component 1202 is configured to replace a media content portion that corresponds to the word or phrase with a different video content portion that corresponds to the word or phrase, and/or also replace, in a slide reel view (e.g., slide reel view 1100), a media content portion that corresponds to the word or phrase with another media content portion that corresponds to another word or phrase of the set of words or phrases.

The ordering component 1204 is configured to modify and/or determine a predefined order of the set of media content portions based on a received modification input for a modified predefined order, in which the communication component 1008 can communicate the modified predefined order in the message with the set of words or phrases in the modified predefined order. For example, a message that is generated by the message component 910 with media content portions to be played in multimedia message such as a video and/or audio message, can be organized in a predefined order that is the order in which the input is provided or received by the message component 910. The ordering component 1204 is thus configured to redefine the predefined order by either drop, drag, and/or some other ordering input that rearranges the slide reel 1100. For example, the video sequence 1100 could be generated in the order in which the input 1210 is received, namely as “I LOVE YOU.” However, the ordering component 1204 is operable to rearrange the phrase and/or words of the concatenated reels without beginning a new message or providing different input 1210. For example, the message could be re-ordered to generate “YOU I LOVE NOT” by also adding “NOT” having a set of media portions associated therewith. A user or device can reorder the phrase I LOVE YOU (that is, if “LOVE YOU” is pieced as words and not grouped as a phrase) and add the input “NOT.” By inputting “NOT,” the user is then able to select from a plurality of media content portions generated from a data store that corresponds with “NOT.”

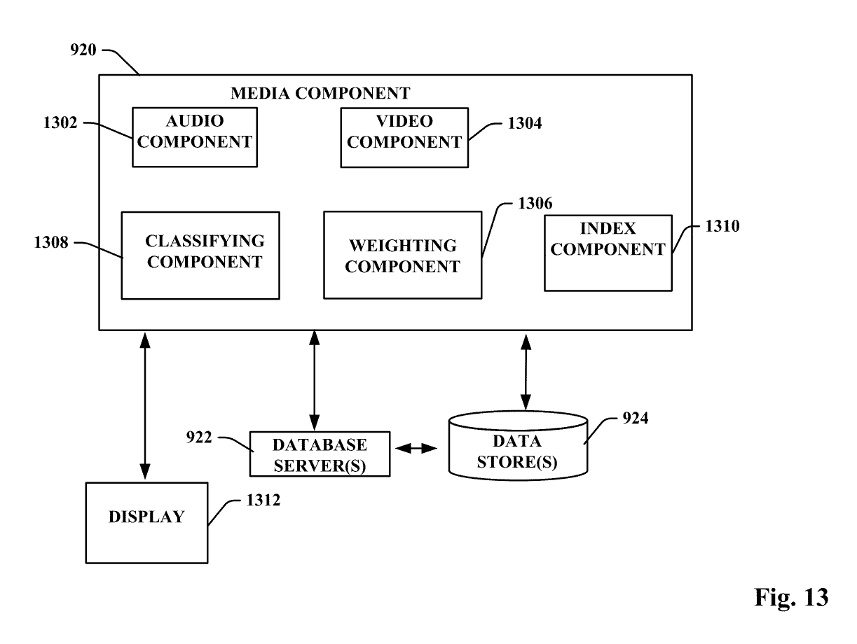

Referring now to FIG. 13, illustrated is an exemplary media component 920 in accordance with various embodiments disclosed herein. The media component 920 further includes an audio component 1302 and a video component 1304. The audio component 1302 is configured to determine a set of audio content portions that respectively correspond to the set of words or phrases according to the set of predetermined criteria. The audio content portions can be generated form a data store of songs, speeches, videos, sound bites and/or other audio recordings stored by a user, a server or some other third party. The audio component 1302 can search for audio within a set of videos while the video component 1304 can search for audio within a set of audio recordings. Likewise, the video component 1304 is configured to determine a set of video content portions that correspond to the set of words or phrases according to the set of predetermined criteria and generate them for the media component 920 to generate a multimedia message as described in this disclosure.

In one embodiment, the audio content and video content generated by the audio component 1302 and the video component 1304 can overlap and generate the same or matching media content in which the audio of each matches a word, phrase and/or image of the inputs received from a user. Additionally, the audio component 1302 and video component 1304 are operable to generate different groups of media content portions to correspond with a phrase, word or image of the input, in which a user could select from the group of media content portions that correspond to a particular phrase, word or image. In addition, a weighting component 1306 can generate a weight indicator according to the set of user classification criteria that can be stored, defined and generated by a classifying component 1308. For example, if a user's preference is set to Western sayings and/or Western movies, then videos and audio of John Wayne or other Western actors could be weight high and ordered in a ranked order from least to greatest or vice versa; while other non-Western media content portions are either not generated or ranked lower. In another embodiment, the video and audio components store and generate upon query predefined video, audio and/or image portions that correspond to a phrase, word, and/or image to automatically be generated based on the input having phrases, words and/or images that is received.

The classifying component 1308 is configured to store and communicate information about the user's preferences to the audio component 1302 and the video component 1304 in order to ensure searches for media content portions are generated according to classification criteria such as by audience categories according to demographic information, such as generation (e.g., gen X, baby boomers, etc.), race, ethnicity, interests, age, educational level, and the like. The user can decide or opt to search video/audio portions, for example, according to theme, genre, actor, awards of recognition, age, rating, religion, etc. according to user's taste and personality desired to be conveyed within the multimedia message generated, for example. The media content portions can then be viewed, previewed or manipulated further in a display 1312.

The media component 920 further comprises and index component 1310 that can index media content portions generated that correspond to various phrases, words, gestures, and/or images according to various classifications discussed herein, such as actors, time periods, country of origin, languages, cultures, ratings, audience, etc. In one example, a server can provide a data store, and/or data base with media content having edited movie clips, video clips, audio clips, image clips, etc., and/or content (e.g., audio, video and the like) in its entirety. In addition, a user can also provide from a data store or memory on a user device, computer device, mobile device and the like with a store of videos, songs, audio content (e.g., speeches, news clips, clips of events, etc.). The media content from any number of data stores external or internal can be analyzed and portioned according to the predetermined criteria discussed herein. The index component 1310, for example, can search according to natural language, imagery analysis, facial recognition, gesture recognition algorithms, etc. to edit and portion sets of media content portions and classify them according to the classification criteria for fast look up and retrieval.

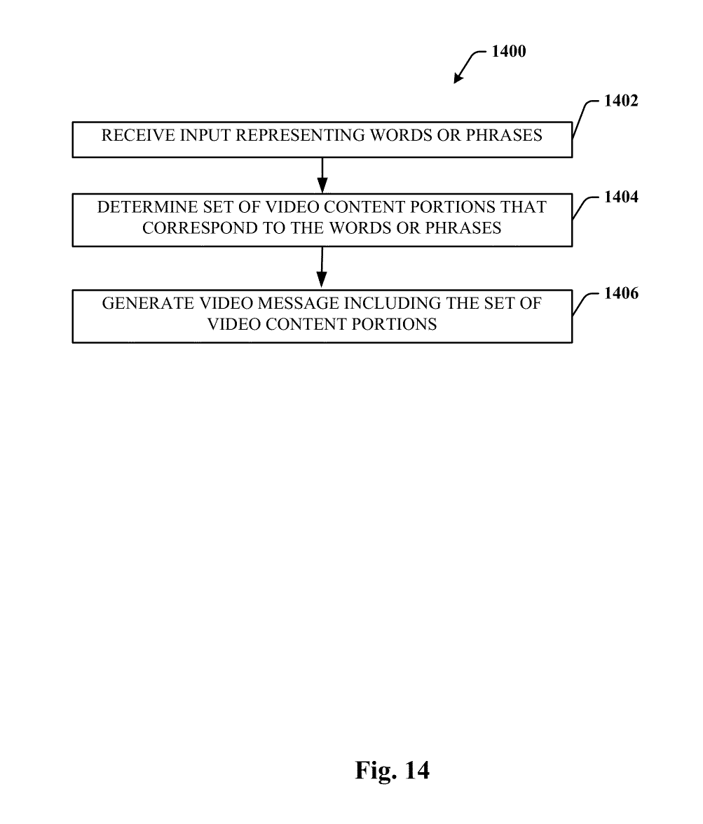

An example methodology 1400 for implementing a method for a messaging system is illustrated in FIG. 14 in accordance with aspects described herein. The method 1400, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 1402, the method initiates with receiving, by a system including at least one processor, a set of text inputs that represent a set of words or phrases for a message. At 1404, a set of video content portions is determined that correspond to the set of words or phrases. The determining can occur according to a set of predetermined criteria. For example, the predetermined criteria can include a matching classification for the set of video content portions according to a set of predefined classifications (e.g., classification criteria), a matching action for the set video content portions with the set of words or phrases, and/or a matching audio clip within the set of video content portions that matches a word or phrase of the set of words or phrases.

At 1406 a video message is generated that includes the set of video content portions that correspond to the words or phrases. The message, for example, can be played as a video movie telegram or video based text message that contains the same audio or actions as that expressed in the input received. For example, the message can be generated as a video stream part that includes concatenated portions of different videos from the set of video content portions determined to correspond to the set of words or phrases, and a text part with text representing the set of words and phrases being configured to be displayed proximate to or overlaying the video stream part. The set of video content portions includes audio content portions that correspond to the set of words or phrases, or a set of actions that correspond to the set of words or phrases.

In another embodiment, the method 1400 can include classifying the set of video content portions according to a set of predefined classifications including at least one of a set of themes for the video content portions, a set of media ratings of the video content portions, a set of target age ranges for the video content portions, a set of voice tones of the video content portions, a set of extracted audio data from the video content portions, a set of actions or gestures included in the video content portions, or an alphabetical order of the set of video content portions.

In another embodiment, the method 1400 can include searching for the set of video content portions that correspond to the set of words or phrases in a networked data store, in a user data store on a mobile device, or from the networked data store and the user data store, and/or extracting a set of audio words and/or a set of images from videos to generate the set of video content portions that correspond to the set of words or phrases.

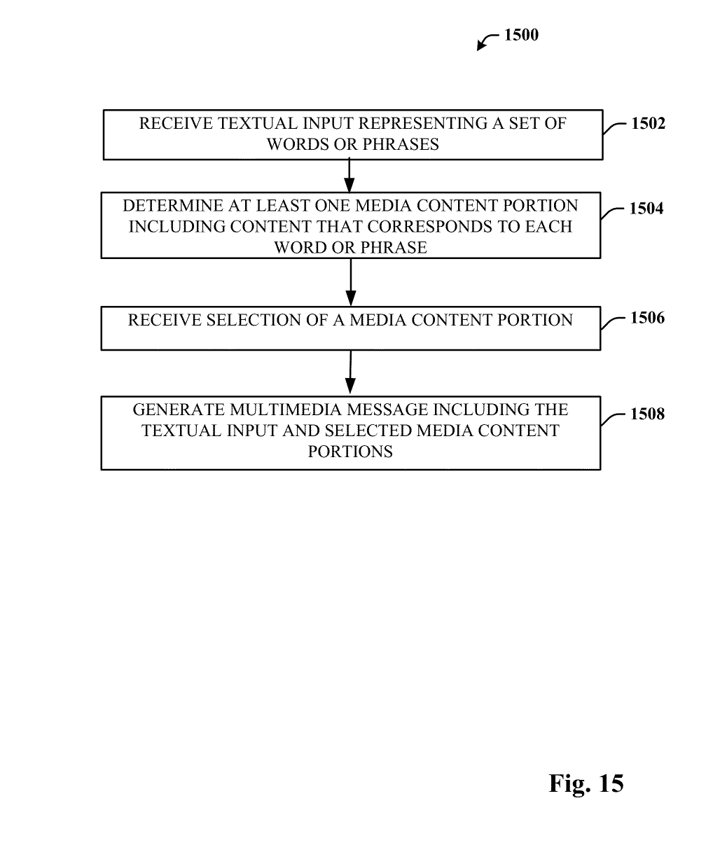

An example methodology 1500 for implementing a method for a system such as a recommendation system for media content is illustrated in FIG. 15. The method 1500, for example, provides for a system to evaluate various media content inputs and generate a sequence of media content portions that correspond to words, phrases or images of the inputs. At 1502, the method initiates with receiving a textual input representing a set of words or phrases of a message to be generated.

At 1502, at least one media content portion including content that corresponds to the word or phrase is determined. At 1506, a selection of a media content portion of the at least one media content portion is received. At 1508, a multimedia message is generated that includes the textual input and the selected media content portions respectively corresponding to the set of words or phrases. The multimedia message can include different portions of videos with audio content or image content

In another embodiment, the method 1500 includes displaying a set of thumbnail images of the selected media content portions in association with displaying respective words or phrases of the set of words or phrases that correspond to the selected media content portions. In addition or alternatively, a word or phrase of the set of words and phrases can be modified to a new word or phrase, and a selection can be received for a new media content portion from a group of media content portions corresponding to the new word or phrase to replace a media content portion associated with the word or phrase.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

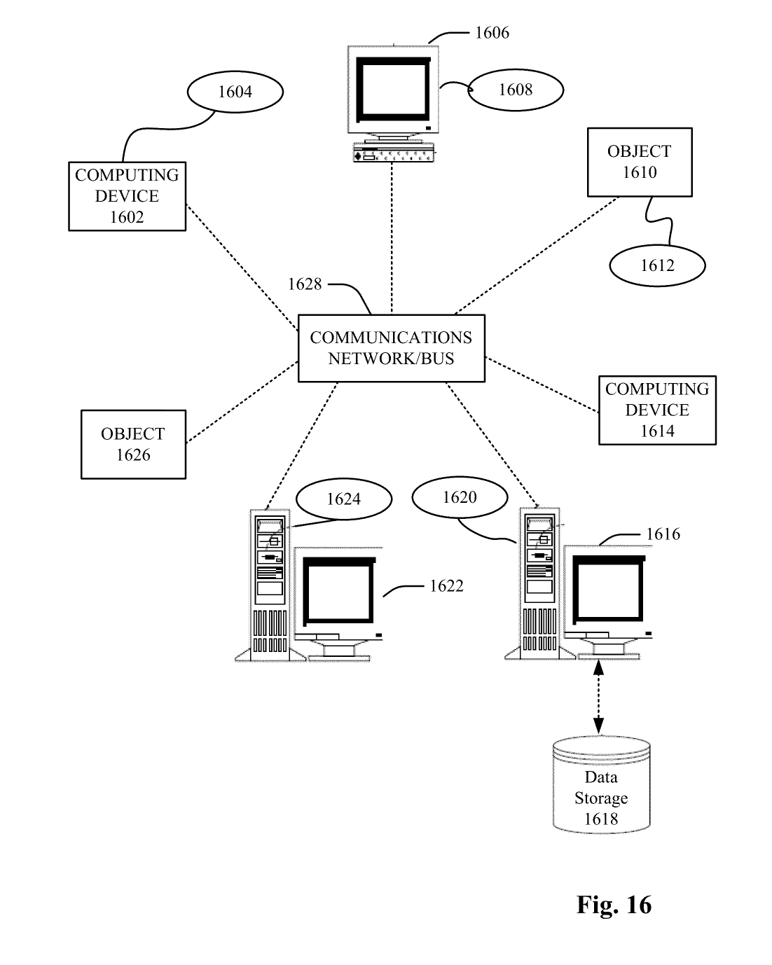

FIG. 16 provides a schematic diagram of an exemplary networked or distributed computing environment. The distributed computing environment comprises computing objects 1610, 1612, etc. and computing objects or devices 1620, 1622, 1624, 1626, 1628, etc., which may include programs, methods, data stores, programmable logic, etc., as represented by applications 1630, 1632, 1634, 1636, 1638. It can be appreciated that computing objects 1610, 1612, etc. and computing objects or devices 1620, 1622, 1624, 1626, 1628, etc. may comprise different devices, such as personal digital assistants (PDAs), audio/video devices, mobile phones, MP3 players, personal computers, laptops, etc.

Each computing object 1610, 1612, etc. and computing objects or devices 1620, 1622, 1624, 1626, 1628, etc. can communicate with one or more other computing objects 1610, 1612, etc. and computing objects or devices 1620, 1622, 1624, 1626, 1628, etc. by way of the communications network 1640, either directly or indirectly. Even though illustrated as a single element in FIG. 16, communications network 1640 may comprise other computing objects and computing devices that provide services to the system of FIG. 16, and/or may represent multiple interconnected networks, which are not shown. Each computing object 1610, 1612, etc. or computing object or device 1620, 1622, 1624, 1626, 1628, etc. can also contain an application, such as applications 1630, 1632, 1634, 1636, 1638, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 16, as a non-limiting example, computing objects or devices 1620, 1622, 1624, 1626, 1628, etc. can be thought of as clients and computing objects 1610, 1612, etc. can be thought of as servers where computing objects 1610, 1612, etc., acting as servers provide data services, such as receiving data from client computing objects or devices 1620, 1622, 1624, 1626, 1628, etc., storing of data, processing of data, transmitting data to client computing objects or devices 1620, 1622, 1624, 1626, 1628, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1640 or bus is the Internet, for example, the computing objects 1610, 1612, etc. can be Web servers with which other computing objects or devices 1620, 1622, 1624, 1626, 1628, etc. communicate via any of a number of known protocols, such as the hypertext transfer protocol (HTTP). Computing objects 1610, 1612, etc. acting as servers may also serve as clients, e.g., computing objects or devices 1620, 1622, 1624, 1626, 1628, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

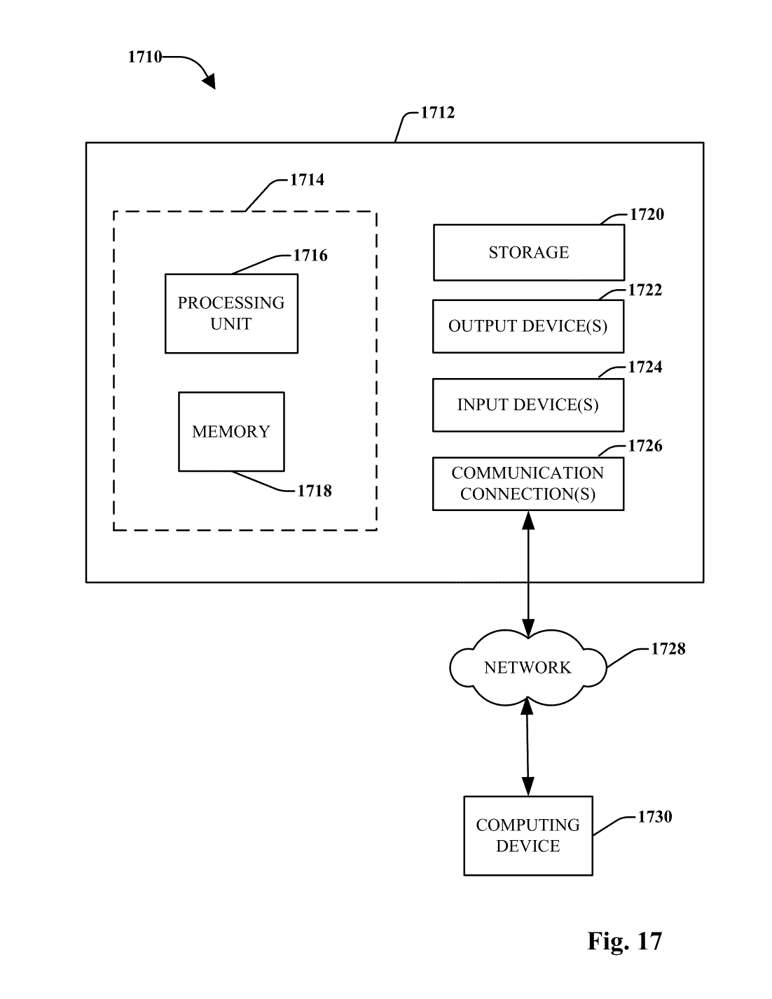

FIG. 17 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 17 illustrates an example of a system 1710 comprising a computing device 1712 configured to implement one or more embodiments provided herein. In one configuration, computing device 1712 includes at least one processing unit 1716 and memory 1718. Depending on the exact configuration and type of computing device, memory 1718 may be volatile (such as RAM, for example), non-volatile (such as ROM, flash memory, etc., for example) or some combination of the two. This configuration is illustrated in FIG. 17 by dashed line 1714.

In other embodiments, device 1712 may include additional features and/or functionality. For example, device 1712 may also include additional storage (e.g., removable and/or non-removable) including, but not limited to, magnetic storage, optical storage, and the like. Such additional storage is illustrated in FIG. 17 by storage 1720. In one embodiment, computer readable instructions to implement one or more embodiments provided herein may be in storage 1720. Storage 1720 may also store other computer readable instructions to implement an operating system, an application program, and the like. Computer readable instructions may be loaded in memory 1718 for execution by processing unit 1716, for example.

The term “computer readable media” as used herein includes computer storage media. Computer storage media includes volatile and nonvolatile, removable and non-removable media implemented in any method or technology for storage of information such as computer readable instructions or other data. Memory 1718 and storage 1720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1712. Any such computer storage media may be part of device 1710.

Device 1712 may also include communication connection(s) 1726 that allows device 1710 to communicate with other devices. Communication connection(s) 1726 may include, but is not limited to, a modem, a Network Interface Card (NIC), an integrated network interface, a radio frequency transmitter/receiver, an infrared port, a USB connection, or other interfaces for connecting computing device 1712 to other computing devices. Communication connection(s) 1726 may include a wired connection or a wireless connection. Communication connection(s) 1726 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1718 and storage 1720 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1710. Any such computer readable storage media may be part of device 1712.

Device 1712 may also include communication connection(s) 1726 that allows device 1712 to communicate with other devices. Communication connection(s) 1726 may include, but is not limited to, a modem, a Network Interface Card (NIC), an integrated network interface, a radio frequency transmitter/receiver, an infrared port, a USB connection, or other interfaces for connecting computing device 1712 to other computing devices. Communication connection(s) 1726 may include a wired connection or a wireless connection. Communication connection(s) 1726 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1712 may include input device(s) 1724 such as keyboard, mouse, pen, voice input device, touch input device, infrared cameras, video input devices, and/or any other input device. Output device(s) 1722 such as one or more displays, speakers, printers, and/or any other output device may also be included in device 1712. Input device(s) 1724 and output device(s) 1722 may be connected to device 1712 via a wired connection, wireless connection, or any combination thereof. In one embodiment, an input device or an output device from another computing device may be used as input device(s) 1724 or output device(s) 1722 for computing device 1712.

Components of computing device 1712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1712 may be interconnected by a network. For example, memory 1718 may be comprised of multiple physical memory units located in different physical locations interconnected by a network.

Those skilled in the art will realize that storage devices utilized to store computer readable instructions may be distributed across a network. For example, a computing device 1730 accessible via network 1728 may store computer readable instructions to implement one or more embodiments provided herein. Computing device 1712 may access computing device 1730 and download a part or all of the computer readable instructions for execution. Alternatively, computing device 1712 may download pieces of the computer readable instructions, as needed, or some instructions may be executed at computing device 1712 and some at computing device 1730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components including:
a media search component configured to identify a set of media content in a set of data stores based on a set of words or phrases;
a media clipping component configured to extract a set of media content portions from the set of media content based on a set of predetermined criteria; and
a concatenating component configured to assemble at least one media content portion of the set of media content portions into a multimedia message based on a set of inputs received for the multimedia message.

2. The system of claim 1, wherein the media clipping component is further configured to divide the set of media content into one or more media content portions that include video content portions and audio content portions based on at least one of words, phrases, or images determined to be included in the video content portions or the audio content portions.

3. The system of claim 1, further comprising:
a media index component configured to index video content portions of the set of media content portions according to words spoken, or phrases spoken within the video content portions, and index the set of media content portions with a set of classifications.

4. The system of claim 1, further comprising an audio analysis component configured to analyze audio content of the set of media content and determine portions of the audio content that correspond to the set of words or phrases of the set of inputs.

5. The system of claim 1, wherein the media search component is further configured to receive at least one query term having the set of words or phrases and to search the set of media content, including video content and audio content, that corresponds with the at least one query term within at least one of a data store of media content on a client device or the set of data stores on a network server via a network connection.

6. The system of claim 1, further comprising:
a publishing component configured to publish, via a network device, the set of media content portions with words or phrases associated with respective media content portions of the set of media content portions, and to publish one or more of the computer executable components for download to a mobile device via the network device.

7. The system of claim 1, further comprising a multimedia server configured to facilitate a sharing of media content of the set of data stores to communicate the respective media content portions of the media content via a network irrespective of physical storage location, and to store an index of different media content portions having video content and audio content based on associations to words or phrases including the set of words or phrases.

8. The system of claim 1, wherein the media search component is further configured to identify the set of media content, including video content and audio content that is associated with the video content, within a data store of videos on a client device and the set of data stores accessible via a network device.

9. The system of claim 1, further comprising a playback component configured to generate a preview of the multimedia message including a rendering of selected media content portions of the set of media content portions in a concatenated video stream.

10. The system of claim 1, wherein the concatenating component is further configured to assemble the at least one media content portion of the set of media content portions into a multimedia message that includes insertion of the at least one media portion into the multimedia message at a location within the multimedia message that corresponds to a corresponding location of a word or phrase within the set of inputs received.

11. The system of claim 10, wherein the at least one media portion includes audio content comprising the word or phrase.

12. The system of claim 1, wherein the multimedia message includes at least two media content portions that correspond to at least two words or phrases of the set of words or phrases included in the set of inputs received.

13. The system of claim 1, further comprising a selection component configured to generate a set of predetermined selections including a set of textual words or phrases that correspond to at least one media content portion of the set of media content portions, and to receive the set of predetermined selections as the set of inputs.

14. The system of claim 1, wherein the media clipping component is further configured to determine the set of media content portions based on a set of audio content pre-associated with a set of video content of the set of media content.

15. The system of claim 13, wherein the media clipping component determines an initial cutting location and an ending cutting location for the set of video content based on a word or phrase within the set of audio content that corresponds with the word or phrase within the set of inputs received, and cuts the set of video content to generate the set of media content portions at the initial cutting location and the ending cutting location in response to the set of inputs.

16. The system of claim 1, further comprising:
a classification component configured to classify the set of media content according to a set of classifications based on at least one of a set of themes, a set of media ratings, a set of actors, a set of song artists, a set of album titles, or a set of date ranges.

17. The system of claim 16, wherein the set of predetermined criteria includes at least one classification of the set of classifications and a matching of media content portions of the set of media content portions from the set of media content with the set of words or phrases.

18. The system of claim 1, wherein the set of predetermined criteria comprises a matching audio clip within the set of media content portions that matches a word or phrase of the set of words or phrases, one or more of a matching classification for the set of video content portions according to a set of predefined classifications, or a matching action for the set video content portions with the set of words or phrases.

19. The system of claim 1, wherein the set of inputs comprise at least one of a voice, or a text input that include at least one of the set of words or phrases.

20. A method, comprising:
identifying, by a system including at least one processor, a set of video content and audio content in a set of data stores based on a set of words or phrases for a multimedia message;
extracting a set of video content portions and audio content portions that correspond to the set of words or phrases according to a set of predetermined criteria; and
assembling at least one video content portion and at least one audio content portion of the set of video content portions and audio content portions into the multimedia message based on a set of inputs having the set of words or phrases.

21. The method of claim 12, further comprising:
dividing the set of video content and audio content into video content portions and audio content portions according to at least one of words, phrases, or images determined to be included in the video content portions or the audio content portions.

22. The method of claim 21, further comprising:
indexing the video content portions and the audio content portions in an index according the at least one of the words, phrases, or images of the set of video content portions and audio content portions.

23. The method of claim 22, further comprising:
classifying the video content portions and the audio content portions according to a set of predefined classifications including at least one of a set of themes, a set of song artists, a set of actors, a set of album titles, a set of media ratings of the set of video content and audio content, voice tone, or a set of time periods, and generating the multimedia message based on the set of inputs having the set of words or phrases and one or more predefined classifications selected from the set of predefined classifications.

24. The method of claim 23, further comprising:
storing the video content portions and the audio content portions in the index based on the set of predefined classifications in the set of data stores that includes at least one data store located on a mobile device.

25. The method of claim 21, wherein the set of predefined criteria includes at least one of a matching of the audio content portions with a word or phrase of the set of words or phrases, or a matching of the video content portions having the at least one audio portion with the word or phrase of the set of words or phrases, and a satisfaction of a set of predefined classifications.

26. The method of claim 20, further comprising:
publishing, via a network, the set of video content portions and audio content portions with words or phrases associated with respective video content portions and audio content portions of the set of video content portions and audio content portions irrespective of physical storage location.

27. The method of claim 20, wherein the identifying the set of video content and audio content in the set of data stores based on the set of words or phrases includes identifying video content and audio content within a user data store of videos on a client device and the set of data stores on a network via a network connection.

28. The method of claim 20, further comprising:
receiving at least one query term having the set of words or phrases; and
searching the set of video content and audio content for the set of video content portions and audio content portions that correspond with the at least one query term within at least one of a user data store of media content on a client device or the set of data stores on a network server via a network connection.

29. The method of claim 20, further comprising:
sharing the set of video content and audio content on the set of data stores; and
communicating the set of video content portions and audio content portions via a cloud network, and to store an index of different media content portions having video content and audio content based on associations to a word or phrase.

30. The method of claim 20, wherein the assembling the at least one video content portion and the at least one audio content portion of the set of video portions and audio content portions into the multimedia message includes matching the set of inputs with a word or phrase of an index having the at least one video content portion and the at least one audio content portion.

31. A non-transitory computer readable storage medium comprising computer executable instructions that, in response to execution, cause a computing system including at least one processor to perform operations, comprising:
searching for a set of words or phrases among a set of video content and audio content in a set of data stores;
identifying at least one word or phrase of the set of words or phrases within the set of video content and audio content searched according to a set of classification criteria;
extracting a set of video content portions and audio content portions having audio content that matches the word or phrase based on the set of classification criteria; and
indexing the set of video content portions and audio content portions having the at least one word or phrase of the set of words or phrases that are pre-associated with video content and audio content of the set of video content and audio content in the set of data stores according to at least one of the at least one word or phrase, or a classification input.

32. The non-transitory computer readable storage medium of claim 31, the operations further including:
communicating the set of video content portions and audio content portions as selections to be inserted into the multimedia message.

33. The non-transitory computer readable storage medium of claim 31, the operations further including:
concatenating at least two video content portions or audio content portions of the set of video content portions and audio content portions into the multimedia message based on a set of selection inputs.

34. The non-transitory computer readable storage medium of claim 31, the operations further including:
indexing the set of video content portions and set of audio content portions according to at least one of words, phrases or images, which are pre-associated with the video content portions or audio content portions.

35. The non-transitory computer readable storage medium of claim 28, the operations further including:
receiving the classification input that selects the set of video content and audio content to be searched in the set of data stores according to the set of classification criteria; and
receiving the at least one word or phrase to be included in the multimedia message to be generated.

36. A system comprising:
means for identifying a set of media content in a set of data stores based on a set of words or phrases for a multimedia message;
means for extracting a set of media content portions having video content and audio content pre-associated with one another that correspond to the set of words or phrases;
means for assembling at least one media content portion of the set of media content portions into the multimedia message based on a set of inputs having the set of words or phrases.

37. The system of claim 36, further comprising:
means for communicating the multimedia message having the at least one media content portion of the set of media content portions that has matching audio content to the set of words or phrases.
